(19) United States
(12) Patent Application Publication
(10) Pub. No.: US 2022/0359862 A1
(43) Pub. Date: Nov. 10, 2022

(54) METHODS AND SYSTEMS FOR CATHODE PRE-LITHIATION LAYER

(71) Applicant: A123 Systems LLC, Waltham, MA (US)

(72) Inventors: Linghong Zhang, St. Paul, MN (US); Xiaorui Chen, Waltham, MA (US); Shaocheng Hu, Xinchang (CH); Xiqing Wang, Windermere, FL (US); Jun Wang, Shrewbury, MA (US); Taehwan Yu, Santa Clara, CA (US); Paul Gionet, Billerica, MA (US)

(21) Appl. No.: 17/659,463

(22) Filed: Apr. 15, 2022

Related U.S. Application Data
(60) Provisional application No. 63/185,297, filed on May 6, 2021.

(51) Int. Cl. H01M 4/36; H01M 10/0525; H01M 10/04; H01M 4/04; H01M 4/62

(52) U.S. Cl. CPC H01M 4/366; H01M 10/0525; H01M 10/0468; H01M 4/0435; H01M 4/0471; H01M 4/0404; H01M 4/625; H01M 2004/021

(57) ABSTRACT

Methods and systems are provided for forming a cathode pre-lithiation layer for a lithium-ion battery. In one example, a slurry for forming the cathode pre-lithiation layer may include a solvent including a uniform dispersion of a nanoscale cathode pre-lithiation reagent. The slurry may be cast onto a porous cathode active material layer and dried and calendered to form the cathode pre-lithiation layer. In some examples, the slurry may have a viscosity of up to 5000 cP at a shear rate of 100 s⁻¹. In this way, delamination and interfacial impedance between the cathode pre-lithiation layer and the porous cathode active material layer may be reduced relative to a higher viscosity cathode pre-lithiation layer having a larger scale cathode pre-lithiation reagent cast onto a non-porous or low-porosity cathode active material layer.

### CROSS-REFERENCE TO RELATED APPLICATIONS

The present application claims priority to U.S. Provisional Application No. 63/185,297, entitled “METHODS AND SYSTEM FOR CATHODE PRE-LITHIATION LAYER”, and filed on May 6, 2021. The entire contents of the above-listed application are hereby incorporated by reference for all purposes.

### FIELD

The present description relates generally to methods and systems for a slurry-based cathode pre-lithiation layer, particularly for a lithium-ion battery.

### BACKGROUND AND SUMMARY

Lithium-ion secondary batteries, or lithium-ion batteries, are widely used in a broad range of applications, including consumer electronics, uninterruptible power supplies, transportation, stationary applications, etc. A lithium-ion battery functions by passing Li⁺ ions from a positive electrode, or cathode, including positive electrode active materials (for example, lithium insertion/deinsertion materials) to a negative electrode, or anode, during battery charging and then passing Li⁺ ions back to the cathode from the anode during battery discharging. A consequence of the charge/discharge process is the formation of a solid-electrolyte interphase (SEI) layer on the anode during the first charge cycle. The SEI layer may prove detrimental to electrochemical performance as the formation process may result in non-negligible Li⁺ consumption (particularly in silicon-based anodes). As such, SEI formation may lower the first-cycle coulombic efficiency (FCE), resulting in lower capacity and lower initial energy density, and thus poor cycling performance, of the lithium-ion battery.

To counter low FCE and resultant capacity and initial energy density loss due to anodic SEI formation, a pre-lithiation approach may be employed to provide the anode with extra Li⁺ ions prior to, or during, first charge/discharge. Pre-lithiation may be accomplished in a number of ways, such as chemical treatment of the anode or incorporation of a sacrificial pre-lithiation reagent having relatively high specific and volumetric capacities at the cathode. To expand on the latter case, the sacrificial pre-lithiation reagent may be added to the cathode such that a greater proportion of Li⁺ ions may be provided by the sacrificial pre-lithiation reagent, resulting in decreased total mass and volume of the cathode to achieve a same full-cell capacity and thus improved energy density.

Relative to anode pre-lithiation techniques, cathode pre-lithiation may be advantageous both from safety and scalability perspectives: as to safety, cathode pre-lithiation involves no handling of volatile Li metal; and as to scalability, cathode pre-lithiation may be incorporated into existing cathode manufacturing processes with comparative ease. However, direct inclusion of cathode pre-lithiation reagents into cathode active material layer slurries may be plagued with other issues. As an example, some cathode pre-lithiation reagents may be relatively sensitive to moisture, potentially leading to degradation of such cathode pre-lithiation reagents prior to desired battery operation voltage windows (e.g., when Li⁺ may be provided to the anode). As another example, some cathode pre-lithiation reagents may be incompatible with common binders [e.g., polyvinylidene fluoride (PVDF)], resulting in slurry gelation and thereby unprocessable slurries or relatively poor quality cathode coatings (e.g., having low adhesion). As yet another example, some cathode pre-lithiation reagents may be incompatible with common slurry solvents [e.g., N-methyl-2-pyrrolidone (NMP)], making retention and dispersion of such cathode pre-lithiation reagents within such slurry solvents difficult.

One alternative includes applying cathode pre-lithiation reagents in separate slurry-based coatings, thereby increasing flexibility at least in terms of binder options (e.g., binder compatibility with cathode active materials and other components of common cathode slurries may decrease in relative importance). Yet moisture sensitivity and, to some extent, solvent selection may remain as impediments to facile inclusion of such slurry-based coatings in cathodes. Further, by layering the slurry-based coating on a preformed cathode substrate (e.g., a cathode active material layer disposed on a cathode current collector), additional interfacial interactions may present obstacles to high quality lamination and ionic and electronic conductivity. Improper coating in this way may also result in undesirably low discharge capacity, which may be caused by increases in impedance ascribed to an additional cathode pre-lithiation layer having an improper design (e.g., high thickness, less effective coating process, etc.) or formulation (e.g., incompatible composition, etc.). Moreover, such interfacial impedance between the cathode pre-lithiation layer and the cathode substrate (in addition to impedance within the cathode pre-lithiation layer) may compromise an overall cycle life and power performance of the lithium-ion battery. Other issues ascribable to improper coating may include delamination or pulverization (e.g., loss of mechanical integrity) of the cathode pre-lithiation later from the cathode substrate, which may obstruct pores in the cathode substrate or a separator included in the lithium-ion battery and concomitantly obstruct Li-ion pathways, potentially leading to compromised electrochemical performance due to impedance increases or uncyclable cells due to internal shortages therein.

The inventors herein have identified the above problems and have determined solutions to at least partially solve them. In one example, a cathode pre-lithiation layer may be applied to a cathode substrate in a slurry-based process and processing parameters may be tuned to optimize electrochemical performance and structural stability of a resultant cathode. In some examples, a pre-lithiation slurry for forming the cathode pre-lithiation layer may be formed by mixing and milling a cathode pre-lithiation reagent in a solvent for a sufficient duration so as to uniformly disperse the cathode pre-lithiation reagent throughout. In an exemplary embodiment, the cathode pre-lithiation reagent may be milled to nanoscale dimensions so as to further improve homogeneity of the resultant pre-lithiation slurry by reducing clumping of the cathode pre-lithiation reagent, thereby improving an overall mechanical integrity of the cathode pre-lithiation layer and reducing interfacial impedance between the cathode pre-lithiation layer and the cathode substrate.

In some examples, the cathode pre-lithiation reagent may be pre-milled in an inert environment prior to mixing and milling the cathode pre-lithiation reagent in the solvent, thereby reducing moisture exposure (e.g., by reducing a duration of subsequent milling) of the cathode pre-lithiation reagent during formation of the pre-lithiation slurry. In some examples, one or more of a cathode catalyst, a binder, and a conductive carbon additive may be added to the pre-lithiation slurry and homogeneously mixed with the cathode pre-lithiation reagent to promote contact therewith. However, certain cathode pre-lithiation reagents may decompose absent the cathode catalyst. Further, and as described below, the cathode pre-lithiation layer may satisfactorily adhere to and coat the cathode substrate without any binder (thus precluding potential issues as to binder compatibility).

The cathode substrate may be manufactured so as to include a relatively high porosity cathode active material layer. Further, a composition and an overall solids content of the pre-lithiation slurry may be controlled so as to lower a resultant viscosity of the pre-lithiation slurry. By pairing the high porosity of the cathode active material layer with the low viscosity of the pre-lithiation slurry, in addition to the nanoscale dimensions of the cathode pre-lithiation reagent, subsequent coating of the pre-lithiation slurry on the cathode active material layer may result in at least some pores of the cathode active material layer being infiltrated by the pre-lithiation slurry. In some examples, structural stability afforded by porous infiltration of at least a portion of the cathode pre-lithiation layer into the cathode active material layer may be sufficient for layer-to-layer adhesion with or without the binder. Thus, as a result of such infiltration, interfacial impedance and delamination issues may be reduced in severity or practically eliminated. Additionally limiting an overall thickness of the cathode pre-lithiation layer may further limit delamination as well as moisture exposure (due to a shorter drying duration of the pre-lithiation slurry and therefore a shorter overall processing duration) and impedance therethrough, further improving electrochemical performance.

In one example, a slurry for forming a cathode pre-lithiation layer may include a uniform dispersion of a nanoscale cathode pre-lithiation reagent in a solvent, wherein the slurry may have a viscosity of up to 5000 cP at a shear rate of 100 s⁻¹. In this way, solvent and binder incompatibility may be mitigated or altogether obviated by leveraging nanoscale dimensions of a uniformly dispersed cathode pre-lithiation reagent in a separate slurry from that employed in forming a cathode active material layer. Further, battery performance issues arising from interfacial impedance and delamination may be avoided when coating the slurry on the cathode active material layer in examples wherein the cathode active material layer has relatively high porosity adjacent to an interface with the slurry.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example process for manufacturing a lithium-ion battery pack including a pre-lithiated cathode having cathode active material and cathode pre-lithiation layers sequentially disposed on a conductive substrate.

FIG. 2A shows a schematic diagram of a first exemplary cathode structure including a cathode pre-lithiation layer.

FIG. 2B shows a schematic diagram of a second exemplary cathode structure including a cathode pre-lithiation layer.

FIG. 2C shows a schematic diagram of a third exemplary cathode structure including a cathode pre-lithiation layer.

FIG. 2D shows a schematic diagram of a fourth exemplary cathode structure including a cathode pre-lithiation layer.

FIG. 3A shows a scanning electron microscope (SEM) image of a coating morphology of a first exemplary cathode pre-lithiation layer.

FIG. 3B shows a scanning electron microscope (SEM) image of a coating morphology of a second exemplary cathode pre-lithiation layer.

FIG. 4 shows a flow chart of a method for forming a pre-lithiated cathode including a slurry-based cathode pre-lithiation layer.

FIG. 5A shows a plot of a relationship between an infiltration depth and a viscosity of a cathode pre-lithiation slurry.

FIG. 5B shows a plot of a relationship between an infiltration depth and a porosity of a cathode pre-lithiation slurry.

FIG. 5C shows a plot of a relationship between a viscosity and a porosity of a cathode pre-lithiation slurry.

FIG. 6 shows a plot of capacity retention over 100 cycles in exemplary lithium-ion batteries.

FIG. 7 shows an SEM image of a cross section of an exemplary porous cathode active material layer.

### DETAILED DESCRIPTION

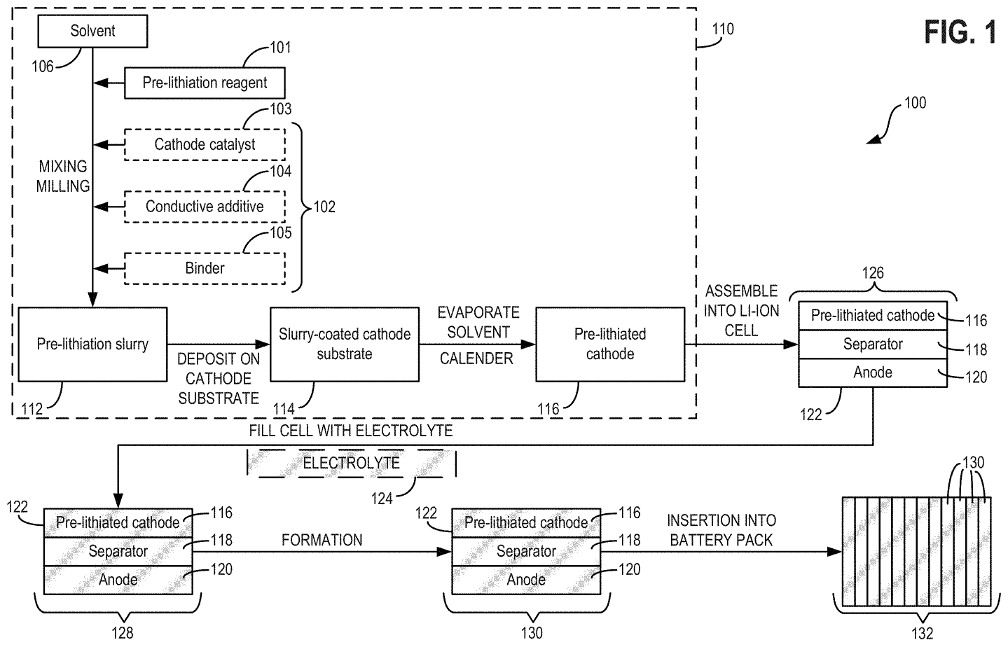

The following description relates to methods and systems for forming cathode pre-lithiation layers and slurries therefor. As described herein with reference to FIG. 1, the cathode pre-lithiation layer may be applied to a cathode substrate to form a pre-lithiated cathode for a lithium-ion secondary battery (referred to herein as a “lithium-ion battery”). The cathode pre-lithiation layer may be formed by casting, drying, and calendering a slurry on the cathode substrate, the slurry including a nanoscale pre-lithiation reagent uniformly dispersed throughout. The uniform dispersion of the nanoscale pre-lithiation reagent in combination with the relatively small physical dimensions thereof may result in an increased mechanical integrity of the finally-formed cathode pre-lithiation layer, as well as facilitating slurry processing and increasing an overall slurry quality. Further, in some examples, the slurry may further include one or more additives, such as a cathode catalyst, a binder, and/or a conductive carbon additive, homogeneously mixed and milled with the nanoscale pre-lithiation reagent in a solvent. Accordingly, increased contact between the nanoscale pre-lithiation reagent and the one or more additives may be realized in the pre-lithiation slurry as well as the finally-formed cathode pre-lithiation layer.

As used herein, “uniform” or “homogeneous” when referring to a dispersion or mixture of one or more components in a slurry or an electrode layer may be used to describe a substantially similar distribution of the component in any given portion of the slurry or the electrode layer. Further, “substantially” may be used herein as a qualifier meaning “effectively.” Further, as used herein, “nanoscale” may refer to physical dimensions which are less than 1 μm. For example, a nanoscale length, a nanoscale area, and a nanoscale volume may be less than 1 μm, 1 μm², and 1 μm³, respectively.

Further slurry processing parameters may be tailored such that an overall duration of slurry processing may be minimized, thereby limiting moisture exposure of the nanoscale pre-lithiation reagent. As an example, the nanoscale pre-lithiation reagent may be pre-milled in an anhydrous solvent or an inert atmosphere to reduce a duration of subsequent mixing and milling the nanoscale pre-lithiation reagent with the one or more additives. As another example, the pre-lithiation slurry may be casted on the cathode substrate at a relatively low loading (e.g., to obtain a relatively small overall thickness of the cathode pre-lithiation layer) such that a duration of drying may be minimized.

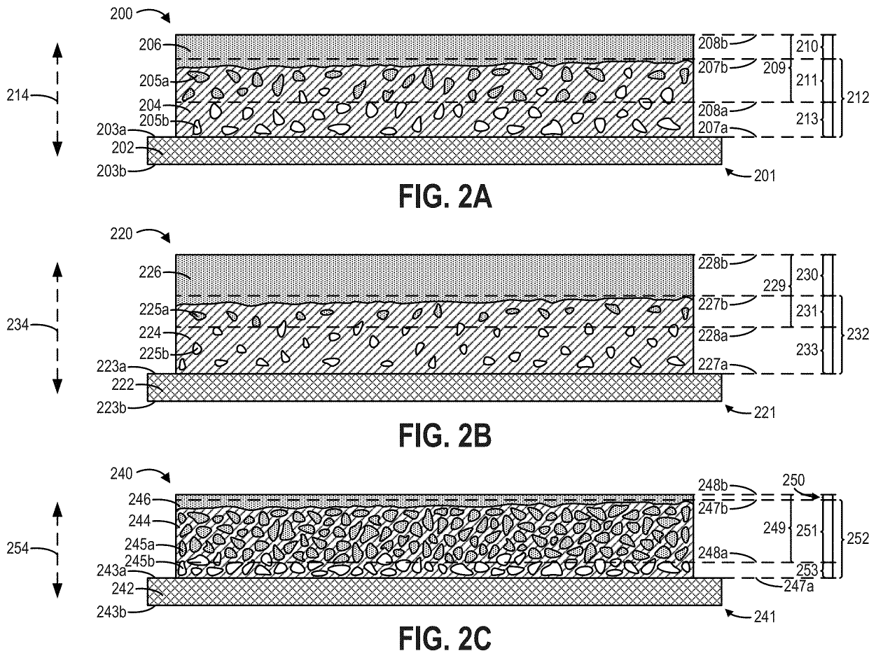

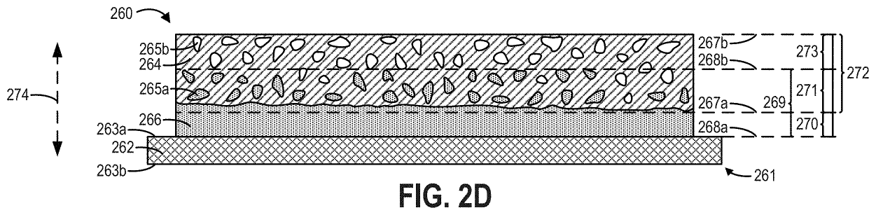

A composition and an overall solids content of the slurry may be selected so as to realize a relatively low viscosity thereof (e.g., between 10 and 5000 cP at a shear rate of 100 s⁻¹). Further, in some examples, the cathode substrate onto which the slurry is cast, calendered, and dried may include a porous cathode active material layer disposed on a conductive substrate. As used herein, “cathode pre-lithiation layer” and related terms and “cathode active material layer” and related terms may be distinguished at least by: (i) the cathode pre-lithiation layer and the cathode active material layer being formed from separate slurries and separately applied during formation of the cathode; and/or (ii) the cathode pre-lithiation layer being formulated to function in tandem with the cathode active material layer to enhance pre-lithiation and Li-ion intercalation/deintercalation of the lithium-ion battery (e.g., the cathode pre-lithiation layer may not function entirely independent of the cathode active material layer to solely drive Li-ion intercalation/deintercalation during battery cycling). For example, and as shown in FIGS. 2A-2D, the (low viscosity) slurry including the nanoscale pre-lithiation reagent may infiltrate adjacent pores in the porous cathode active material layer such that sufficient layer-to-layer adhesion may be achieved between the cathode pre-lithiation layer formed from the slurry and the porous cathode active material layer and interfacial impedance and delamination may be mitigated (as used herein, “adjacent pores” may be used to describe vacant pores of a first electrode layer located proximate to a second electrode layer in contact with or infiltrating the first electrode layer, where no intervening pores are located therebetween).

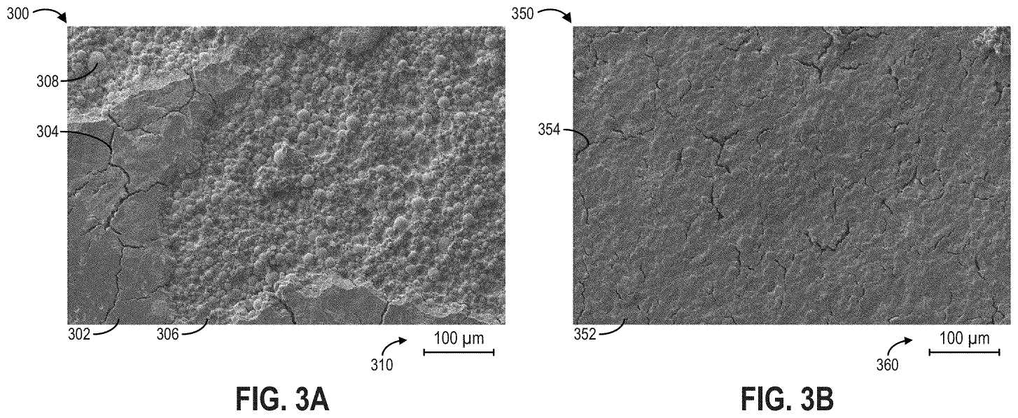

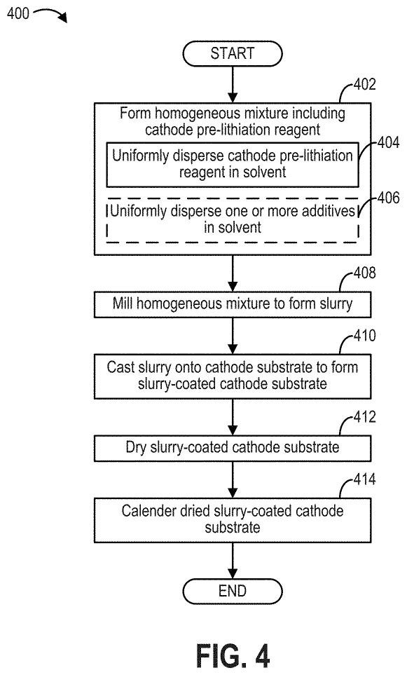

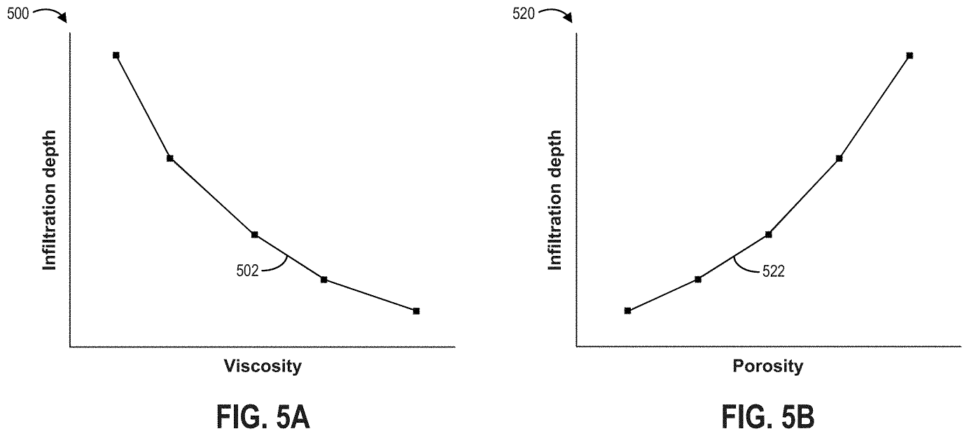

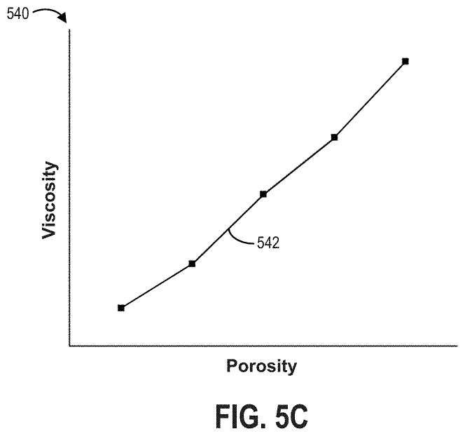

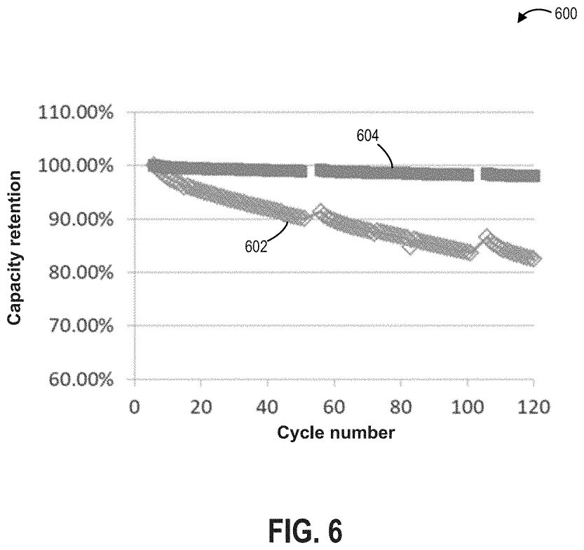

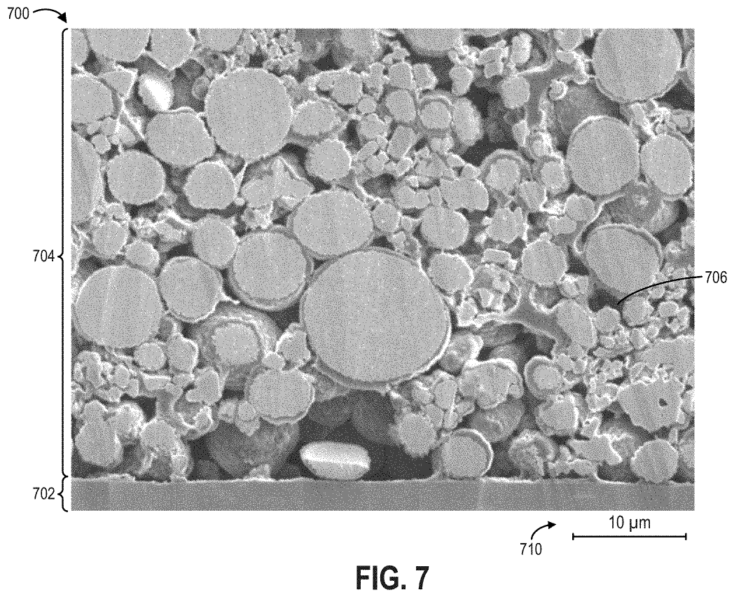

Pairwise relationships between a viscosity of the slurry, a porosity of the porous cathode active material layer, and an infiltration depth of the cathode pre-lithiation layer formed from the slurry, into the porous cathode active material layer, are illustrated by plots depicted in FIGS. 5A-5C. FIGS. 3A and 3B depict scanning electron microscope (SEM) images illustrating relative differences in layer-to-layer adhesion of pre-lithiation layers applied with high and low viscosity slurries. FIG. 7 depicts an SEM image of a cross section of a porous cathode active material layer, illustrating relative size relationships of pores therein and distances between such pores. A method for forming the slurry including the uniform dispersion of the nanoscale pre-lithiation reagent and casting, drying, and calendering the slurry to form the cathode pre-lithiation layer on the porous cathode active material layer so as to attain desirable layer-to-layer adhesion and maintain relatively low interfacial impedance, as well as lower impedance throughout the cathode pre-lithiation layer (e.g., by limiting the overall thickness of the cathode pre-lithiation layer), is detailed in FIG. 4. As such, a pre-lithiated cathode which may be included in a lithium-ion cell of a lithium-ion battery pack may be formed by the method of FIG. 4. Cycling performance of an exemplary lithium-ion battery including a pre-lithiated cathode relative to an exemplary lithium-ion battery including a cathode without a pre-lithiation reagent is illustrated by a plot shown in FIG. 6.

Referring now to FIG. 1, a schematic diagram 100 depicts an example process for manufacturing a lithium-ion battery pack 132. The lithium-ion battery pack 132 may include a plurality of lithium-ion cells 130, where each of the plurality of lithium-ion cells 130 may include a pre-lithiated positive electrode 116 (also referred to herein as a “pre-lithiated cathode” or a “cathode”) formed via a cathode pre-lithiation slurry manufacturing process 110. FIG. 1 shows one of the lithium-ion cells 130 including the pre-lithiated cathode 116, a separator 118, and an anode 120, each forming a layer of the lithium-ion cell 130. It will be appreciated that the lithium-ion cell 130 illustrated in FIG. 1 is a representative, non-limiting example. In other examples, the lithium-ion cell 130 may include a stack formed of repeating layers of the pre-lithiated cathode 116, the separator 118, and the anode 120, the layers repeated in a quantity determined based on desired properties of the plurality of lithium-ion cells 130.

The cathode pre-lithiation slurry manufacturing process 110 may include mixing and milling a pre-lithiation reagent 101 and one or more additives 102 in a solvent 106 to form a pre-lithiation slurry 112. The pre-lithiation reagent 101 may include a cathode pre-lithiation reagent, selected so as to decompose prior to, or during, initial charging of the lithium-ion battery pack 132 (e.g., when Li⁺ ions are flowing from the pre-lithiated cathode 116 to the anode 120) when incorporated into the pre-lithiated cathode 116. For example, the pre-lithiation reagent 101 may be composed of one or more of lithium nitride (Li₃N), lithium oxide or lithia (Li₂O), lithium peroxide (Li₂O₂), lithium sulfide (Li₂S), lithium iron oxide (Li₅FeO₄ or LFO), and a conversion-type nanocomposite. The conversion-type nanocomposite may be a blend of one or more metals and one or more lithium compounds [e.g., Li₂S, lithium fluoride (LiF), and Li₂O], where a conversion reaction between the one or more metals and the one or more lithium compounds may release Li⁺ ions and a corresponding metal compound (e.g., a metal sulfide, a metal fluoride, or a metal sulfide). In one example, the conversion-type nanocomposite may include one or more of a Li₂S/M nanocomposite, a LiF/M nanocomposite, and a Li₂O/M nanocomposite (where M is one or more metals, such as Co, Ni, Mn, and/or Fe). In some examples, the pre-lithiation reagent 101 may be in the form of particulates, each of the particulates including a core material with a surface impurity layer formed thereon. In one such example, the core material may include one or more of Li2O₂, Li₂O, and Li₂S and the surface impurity layer may include one or more of lithium hydroxide (LiOH) and lithium carbonate (Li₂CO₃).

The pre-lithiation reagent 101 may be in the form of particulates or particles. The pre-lithiation reagent 101 particles may have a range of sizes or may be close in size. During preparation of the pre-lithiation slurry 112, the pre-lithiation reagent 101 particles may be milled to a nanoscale size. As one example, the pre-lithiation reagent 101 particles may have a D50 size range of 1 μm or less in the pre-lithiation slurry 112 (e.g., following milling). In some examples, the pre-lithiation reagent 101 particles may have the D50 size range of 300 nm or less in the pre-lithiation slurry 112. In some examples, the pre-lithiation reagent 101 particles may have the D50 size range of 150 nm or less in the pre-lithiation slurry 112.

In some examples, the pre-lithiation reagent 101 particles may be substantially round. In additional or alternative examples, the pre-lithiation reagent 101 particles may be flakes, such that the particles are approximately plate-shaped. In additional or alternative examples, the pre-lithiation reagent 101 particles may be irregularly shaped, such that the particles do not approximate common geometric shapes, and that the particles vary in shape and/or size relative to one another.

Milling of the pre-lithiation reagent 101 may be conducted in a single milling step or in multiple milling steps. For example, the pre-lithiation reagent 101 may be at least partially milled (“pre-milled”) in a first milling step prior to being added to the solvent 106 and the pre-lithiation reagent 101 may be further milled in a second milling step following addition to the solvent 106. Alternatively, the pre-lithiation reagent 101 may only be milled following addition to the solvent 106.

The pre-lithiation reagent 101 may be up to 100% of physical solids in the finally-formed pre-lithiation slurry 112 (e.g., the pre-lithiation reagent 101 may be the only solid component dispersed in the solvent 106, as discussed below). In some examples, the pre-lithiation reagent 101 may be 50% or less or 30-90% of the physical solids in the pre-lithiation slurry 112.

The one or more additives 102 may include, for example, one or more of a cathode catalyst 103, a conductive additive 104, and a binder 105. As shown, the one or more additives 102 are schematically depicted in dashing, indicating that at least one of the one or more additives 102 may be omitted in one or more embodiments of the present disclosure. As an example, the pre-lithiation reagent 101 may include a compound, such as Li₃N, which decomposes absent the cathode catalyst 103 at practical cathode potentials. In such an example, no cathode catalyst 103 may be added to or included in the pre-lithiation slurry 112 or the lithium-ion battery pack 132 (e.g., prior to initial cycling). As another example, the binder 105 may be omitted based on sufficient infiltration of the finally formed pre-lithiation slurry 112 into a cathode substrate (as discussed below). In such an example, no binder 105 may be added to or included in the pre-lithiation slurry 112.

In some examples, the cathode catalyst 103 may be added to the solvent 106 prior to, along with, or following the pre-lithiation reagent 101. The cathode catalyst 103 may include any material which catalyzes decomposition of the pre-lithiation reagent 101 such that sufficient Li⁺ may be released therefrom during pre-lithiation of the finally-formed lithium-ion battery pack 132. Further, the cathode catalyst 103 may include a material which may not be consumed during a first charge cycle of the finally-formed lithium-ion battery pack 132 and which may not fully decompose during a lifetime of the lithium-ion battery pack 132 (such that at least some residual cathode catalyst 103 may remain in the lithium-ion battery pack 132 following initial charge cycling).

In some examples, the cathode catalyst 103 may include a lithium-based active cathode catalyst, wherein the lithium-based active cathode catalyst may be any lithium compound which reversibly releases and accepts lithium ions during a charge cycle (e.g., a lithium insertion/deinsertion compound) and catalyzes the decomposition of the pre-lithiation reagent 101 [in certain examples, the lithium-based active cathode catalyst may catalyze the decomposition of the pre-lithiation reagent 101 while in a delithiated state (e.g., following release/deinsertion of lithium ions from the lithium-based active cathode catalyst)]. For example, the cathode catalyst 103 may be composed of one or more lithium metal phosphates [e.g., one or more lithium transition metal phosphates, such as a lithium iron phosphate (LFP) or a lithium manganese iron phosphate (LMFP)] and/or one or more lithium metal oxides [e.g., one or more lithium transition metal oxides, such as a lithium nickel manganese cobalt oxide (NMC)]. In some examples, the cathode catalyst 103 may include a non-lithium metal-based inactive cathode catalyst. For example, the cathode catalyst 103 may be composed of one or more non-lithiated metal nitrides, one or more binary non-lithiated metal oxide/nitride systems, one or more ternary non-lithiated metal oxide/nitride systems, one or more non-lithiated metal phosphates [e.g., one or more non-lithiated transition metal phosphates, such as an iron phosphate (FP) or a manganese iron phosphate (MFP)], and/or one or more non-lithiated metal oxides [e.g., one or more non-lithiated metal oxides, such as cobalt (II,III) oxide (CO₃O₄), nickel (II) oxide (NiO), iron (II,III) oxide (Fe3O4), or cobalt ferrite (CoFe₂O₄)]. In one example, the cathode catalyst 103 may include a transition-metal based compound with partially populated d and/or f orbitals, which may instigate electronic transitions and lower an activation energy for the decomposition of the pre-lithiation reagent 101.

In some examples, the conductive additive 104 may be added to the solvent 106 prior to, along with, or following the pre-lithiation reagent 101. The conductive additive 104 may include a carbonaceous conductive additive, which may increase an electronic conductivity and reduce a total amount of carbon utilized in preparation of the cathode substrate (e.g., in forming a cathode active material layer thereof). In some examples, the conductive additive 104 may be composed of one or more of carbon black, carbon fibers, carbon nanoparticles, carbon nanotubes (CNTs), graphene, and graphene oxide.

The conductive additive 104 may be in the form of particulates or particles. The conductive additive 104 particles may have a range of sizes or may be close in size. During preparation of the pre-lithiation slurry 112, the conductive additive 104 particles may be milled to a predetermined size. As an example, the conductive additive 104 particles may have a D50 size range of 0.5 μm or less in the pre-lithiation slurry 112 (e.g., following milling). As an additional or alternative example, the conductive additive 104 particles may have the D50 size range of 150 nm or less in the pre-lithiation slurry 112. In some examples, the conductive additive 104 particles may be substantially round. In additional or alternative examples, the conductive additive 104 particles may be flakes, such that the particles are approximately plate-shaped. In additional or alternative examples, the conductive additive 104 particles may be irregularly shaped, such that the particles do not approximate common geometric shapes, and that the particles vary in shape and/or size relative to one another. In additional or alternative examples, the conductive additive 104 may be in the form of fibers.

As an example, the conductive additive 104 may be up to 20% of physical solids in the finally-formed pre-lithiation slurry 112. In some examples, the conductive additive 104 may be 20% or less or 5-25% of the physical solids in the pre-lithiation slurry 112.

In some examples, the binder 105 may be added to the solvent 106 prior to, along with, or following the pre-lithiation reagent 101. The binder 105 may be flexible in terms of composition, as the binder 105 may include compounds selected regardless of compatibility with common cathode active materials (e.g., in examples wherein the cathode catalyst 103 does not include the active, lithium-based cathode catalyst). In some examples, for instance, the binder 105 may be unable to bind NMC when the finally-formed pre-lithiated cathode 116 is expanded during charge/discharge cycling. For example, the binder 105 may be composed of one or more of polyacrylonitrile (PAN), polyethylene glycol (PEG), polyvinylidene fluoride (PVDF), polytetrafluoroethylene (PTFE), polyhexafluoropropylene (PHFP), poly(methyl methacrylate) (PMMA), poly(acrylic acid) (PAA), poly(4-vinylpyridine), polyvinylpyrrolidone, a carboxymethyl cellulose (CMC) derivative, or a co-polymer of any the preceding compounds. In some examples, a molecular weight of the binder 105 may be between 50 kDa and 5 MDa. In other examples, the molecular weight of the binder 105 may be between 500 kDa and 2 MDa. In some examples, the binder 105 may be selected to substantially dissolve in the solvent 106 (for example, the binder 105 may be PVDF and the solvent 106 may be NMP).

As an example, the binder 105 may be up to 15% of physical solids in the finally-formed pre-lithiation slurry 112. In some examples, the binder 105 may be 5% of the physical solids in the pre-lithiation slurry 112. Additionally or alternatively, the binder 105 may be 5-20% of the physical solids in the pre-lithiation slurry 112. Additionally or alternatively, the binder 105 may have a concentration of up to 10% in the pre-lithiation slurry 112.

In some examples, the solvent 106 may include a non-aqueous or organic solvent. For example, the solvent 106 may be composed of one or more of dimethylformamide (DMF), NMP, dimethylacetamide (DMAc), dimethyl sulfoxide (DMSO), acetonitrile (MeCN), tetrahydrofuran (THF), and toluene.

In some examples, an overall composition and a solids content of the pre-lithiation slurry 112 may be tailored to achieve a desired viscosity thereof. As an example, the overall composition of the pre-lithiation slurry 112 may include one or more pre-lithiation reagents 101, one or more cathode catalysts 103, the conductive additive 104, and the binder 105. As an additional or alternative example, the solids content of the pre-lithiation slurry 112 may be between 10-70% or between 10-40%. In one example, the pre-lithiation slurry 112 may have a relatively low viscosity of up to 5000 cP at a shear rate of 100 s⁻¹. In another example, the pre-lithiation slurry 112 may have a viscosity of 100 to 5000 cP at a shear rate of 100 s⁻¹. In another example, the pre-lithiation slurry 112 may have a viscosity of 10 to 5000 cP at a shear rate of 100 s⁻¹. In yet another example, the pre-lithiation slurry 112 may have a viscosity of 10 cP to 100 cP at a shear rate of 100 s⁻¹. By forming the pre-lithiation slurry 112 in this way, higher viscosities may be avoided, which may result in poor coating of the pre-lithiation slurry 112 on the cathode substrate and may delaminate or have undesirably high interfacial impedance in the pre-lithiated cathode 116 as finally formed.

In some examples, the pre-lithiation slurry 112 may include a cathode active material (e.g., greater than a negligible amount thereof). In one example, the only cathode active material included in the pre-lithiation slurry 112 may be the active, lithium-based cathode catalyst included in the cathode catalyst 103 (e.g., at 50 wt % or less of the pre-lithiation slurry 112) and no additional cathode active material may be included in the pre-lithiation slurry 112. In other examples, no cathode active material may be included in the pre-lithiation slurry 112.

In some examples, the pre-lithiation reagent 101 (optionally with the one or more additives 102) may be mixed in the solvent 106 in a planetary centrifugal mixer cup or other vessel. In other examples, mixing may be performed on a larger scale (e.g., planetary, centrifugal, and/or rotary blade mixing). In some examples, mixing may be conducted for a sufficient duration of time (e.g., 24 hours) to achieve a uniform dispersion of components (e.g., the pre-lithiation reagent 101, the one or more additives 102, etc.) in the solvent 106. In some examples, mixing may be conducted at 2000 RPM. The nanoscale dimensions of the pre-lithiation reagent 101, in combination with the uniform dispersion thereof in the solvent 106, may improve a mechanical integrity of the (finally formed) pre-lithiated cathode 116 (e.g., by avoiding clumping of the pre-lithiation reagent 101 and reducing interactions between particles thereof).

Further, in examples wherein the one or more additives 102 are mixed in the solvent 106 with the pre-lithiation reagent 101, the uniform dispersion of the pre-lithiation reagent 101 and the one or more additives 102 may promote increased contact therebetween. Additionally, as nanoscale dimensions of the pre-lithiation reagent 101 particles may increase an overall surface area relative to similarly shaped particles having larger dimensions, greater opportunities still for contact with the one or more additives 102 may be afforded. Such greater contact between the pre-lithiation reagent 101 and the one or more additives 102 may improve electrochemical performance of the finally-formed lithium-ion battery pack 132. For example, when greater contact exists between the pre-lithiation reagent 101 particles and the cathode catalyst 103 particles, pre-lithiation in the lithium-ion battery pack 132 may be more effectively catalyzed and may proceed at a correspondingly faster rate.

Thus, a homogeneous mixture or solution of the pre-lithiation reagent 101, with the one or more additives 102 if desired, in the solvent 106 may be formed. Following mixing, the mixture may be milled such that particles of the pre-lithiation reagent 101 may be reduced in size (e.g., to less than 300 nm) and a size distribution of the particles of the pre-lithiation reagent 101 may be narrowed. In examples wherein the one or more additives 102 are added to the solvent 106, milling may occur prior to addition of the one or more additives 102 (e.g., such that only the pre-lithiation reagent 101 is milled) or following addition of the one or more additives 102 (e.g., such that the one or more additives 102 are milled with the pre-lithiation reagent 101). Milling may be accomplished by adding an inert media, such as a ceramic milling media, to a volume along with the homogeneous mixture. In some examples, the volume may be milled for a sufficient duration of time (e.g., 24 hours) to achieve a desired size and size distribution of particles included in the homogeneous mixture. As a duration of milling increases, the size of the particles included in the volume may decrease and the size distribution of the particles included in the volume may narrow.

In some examples of the pre-lithiation slurry manufacturing process 110, the pre-lithiation slurry 112 may be deposited, or cast, onto a cathode substrate to form a slurry-coated cathode substrate 114. The cathode substrate may include a conductive substrate (also referred to herein as a “current collector,” a “positive electrode current collector,” or a “cathode current collector”) having a cathode active material layer deposited thereon. Accordingly, the pre-lithiation slurry 112 may be cast onto the cathode active material layer of the cathode substrate. In other examples, the cathode substrate may only include the conductive substrate such that the pre-lithiation slurry 112 may be cast directly thereon. In such examples, the cathode active material layer may be formed on the cast pre-lithiation slurry 112 such that that pre-lithiation slurry 112 may be interposed between the conductive substrate and the cathode active material layer (where the pre-lithiation slurry 112 may be dried and calendered prior to or following formation of the cathode active material layer). Further, in such examples, the binder 105 may be included in the pre-lithiation slurry 112 and selected so as to bind components of the cathode active material layer to the conductive substrate.

The conductive substrate or current collector may be a metal foil, such as aluminum foil. In some examples, the current collector may be aluminum foil and may have a thickness of 1-20 μm. In some examples, the current collector may be aluminum foil and may have the thickness of about 10 μm (as used herein, “about” when referring to a numerical value may encompass a deviation of 5% or less).

As discussed in detail below with reference to FIGS. 2A-2D, the cathode active material layer may have a relatively high porosity (e.g., greater than 40%, such as when the cathode active material layer is not calendered). Such relatively high porosity, in combination with the relatively low viscosity of the pre-lithiation slurry 112 and the nanoscale dimensions of the pre-lithiation reagent 101 (in addition to other additives, if present and milled to nanoscale dimensions as well), may permit at least partial infiltration of pores of the cathode active material layer with the pre-lithiation slurry 112 during casting thereof. However, in considering sufficient retention and infiltration of the pre-lithiation slurry 112 in the cathode substrate, an exceptionally low viscosity (e.g., less than 10 cP at a shear rate of 100 s⁻¹) may be less problematic when applied to a cathode active material layer with relatively low porosity, while a cathode active material layer with an exceptionally high porosity (e.g., greater than 40%) may be less problematic when a slurry having relatively high viscosity is applied thereto. Accordingly, selection of the viscosity of the pre-lithiation slurry 112 and the porosity of the cathode active material layer may not be immediately apparent even to those of ordinary skill in the art and extensive experimentation may be employed to determine optimal ranges for balancing desired slurry cohesion, infiltration, and subsequent layer-to-layer adhesion.

The cathode active material layer may be prepared and deposited, or cast, onto the conductive substrate as a separate slurry-based coating prior to casting of the pre-lithiation slurry 112. In an exemplary embodiment, a cathode active material slurry may be prepared separately from the pre-lithiation slurry 112 and cast onto the conductive substrate to form the cathode active material layer prior to casting of the pre-lithiation slurry 112 on the cathode substrate (e.g., onto the formed cathode active material layer). In one example, the pre-lithiation slurry 112 may have a lower viscosity than the cathode active material slurry. In another example, the pre-lithiation slurry 112 may have a substantially similar viscosity to the cathode active material layer.

The pre-lithiation slurry 112 may be deposited, or cast, onto the cathode substrate. For example, following casting of the cathode active material slurry, the pre-lithiation slurry 112 may be cast onto the cast (wet) cathode active material slurry or the cathode active material layer as finally formed (e.g., following casting, drying, and calendering of the cathode active material slurry). In one example, the pre-lithiation slurry 112 may be cast at a predetermined loading via roll-to-roll coating utilizing a slot-die coater or a doctor blade method. Additionally or alternatively, pre-lithiation slurry 112 may be cast via an extrusion coating process, a spin coating process, a spray coating process, and/or a micro gravure coating method.

In some examples, after the pre-lithiation slurry 112 is deposited onto the cathode substrate to form the slurry-coated cathode substrate 114, the solvent 106 may be dried off, or evaporated, with gentle heating. The gentle heating may include heating the slurry-coated cathode substrate 114 to a heating temperature of between 20 and 300° C. In some examples, the cathode active material layer may be dried at a similar heating temperature (e.g., between 20 and 300° C.) prior to the pre-lithiation slurry 112 being applied cast thereon. However, in other examples, retention of the pre-lithiation slurry 112 on the cathode active material layer (and subsequent layer-to-layer adhesion between the cathode active material layer and a pre-lithiation layer formed from the pre-lithiation slurry 112) may be further improved by casting the pre-lithiation slurry 112 on the cathode active material layer prior to drying of the cathode active material layer (e.g., when the cathode active material layer is still wet). Accordingly, in such examples, the pre-lithiation slurry 112 and the cathode active material layer may be dried together in a single drying process. In some examples, a porosity of the cathode active material layer may be increased when the slurry-coated cathode substrate 114 is dried, improving layer-to-layer adhesion further still. As one example, the porosity of the cathode active material layer may increase with increasing heating temperature during drying.

A dried film or coating formed from drying the slurry-coated cathode substrate 114 may be calendered to a predetermined density to obtain a smooth pre-lithiation layer and the pre-lithiated cathode 116 may be formed. Further, by adjusting parameters (e.g., durations, temperatures, methods, etc.) of casting, drying, and calendering of the pre-lithiation slurry 112, an overall thickness of the pre-lithiation layer may be controlled to a value or within a range of values predetermined based on various application-specific parameters, such as a desired increase in Li⁺ ion inventory from decomposition of the pre-lithiation reagent 101, a desired cycle life, a desired energy density, and a desired overall thickness of the pre-lithiated cathode 116 (all of which may depend proportionally on the overall thickness of the pre-lithiation layer). For example, after calendering, the overall thickness of the pre-lithiation layer may be controlled to 200 μm or less.

Further, and as described in detail below with reference to FIGS. 2A-2D, the pre-lithiation layer may extend away from the cathode active material layer up to a maximum extent and/or the pre-lithiation layer may infiltrate the cathode active material layer up to a maximum infiltration depth, where a sum of the maximum extent and the maximum infiltration depth may be equal to the overall thickness. As an example, each of the maximum extent and the maximum infiltration depth may be greater than 0 μm and less than the overall thickness, such that the pre-lithiation layer may partially infiltrate the pores of the cathode active material layer (e.g., only a portion of the pre-lithiation layer may infiltrate the pores of the cathode active material layer). As another example, the maximum extent may be equal to the overall thickness and the maximum infiltration depth may be 0 μm, such that the pre-lithiation layer may be in face-sharing contact with the cathode active material layer and may not infiltrate the pores of the cathode active material layer. As yet another example, the maximum extent may be 0 μm and the maximum infiltration depth may be equal to the overall thickness, such that an entirety of the pre-lithiation layer may infiltrate the pores of the cathode active material layer.

In this way, the cathode pre-lithiation slurry manufacturing process 110 may include mixing and milling the pre-lithiation reagent 101 in the solvent 106 (with or without the one or more additives 102) to form the pre-lithiation slurry 112, coating the pre-lithiation slurry 112 onto the cathode substrate to form the slurry-coated cathode substrate 114, and compressing, or calendering, the dried film. It will be appreciated that, within the cathode pre-lithiation slurry manufacturing process 110, additional additives or processes may be included or removed or substantially altered as contemplated by one of ordinary skill in the art.

By ensuring that the pre-lithiation layer is sufficiently adhered to the cathode active material layer in the pre-lithiated cathode 116 as described above, electrochemical performance of the finally-formed lithium-ion battery pack 132 may be improved relative to a lithium-ion battery pack including a pre-lithiated cathode having an improperly adhered pre-lithiation layer. Further, and as illustrated in Table 1 below, electrochemical performance of the lithium-ion battery pack 132 (including the pre-lithiated cathode 116) may be improved relative to a lithium-ion battery pack including a cathode without a pre-lithiation reagent. For example, to achieve an equivalent first charge capacity (FCC) value to the lithium-ion battery pack including the cathode without the pre-lithiation reagent, the pre-lithiated cathode 116 may have a reduced total coating thickness (e.g., a sum of a thickness of the cathode active material layer and a thickness of the pre-lithiation layer) and a reduced loading at a press density of 3.4 g/cc relative to the cathode without the pre-lithiation reagent. In terms of electrochemical performance, decreasing the loading (e.g., decreasing a cathode weight) may increase a specific energy density and decreasing the total coating thickness (e.g., decreasing a cathode thickness) may increase a volumetric energy density. In one example, and as discussed in detail below with reference to FIGS. 3A and 3B, a first charge capacity (FCC) of the lithium-ion battery pack 132 may be 275 mAh/g or greater, a first discharge capacity (FDC) of the lithium-ion battery pack 132 may be 225 mAh/g or greater, and a first cycle coulombic efficiency (FCE) of the lithium-ion battery pack 132 may be 80% or greater. Moreover, the pre-lithiated cathode 116 may confer improved cycle life relative to the lithium-ion battery pack 132 relative to the lithium-ion battery pack including the cathode without the pre-lithiation reagent (see, e.g., FIG. 6).

TABLE 1
Loadings and total coating thicknesses for exemplary
cathodes included in exemplary lithium-ion battery packs.

| | | | Total |
|---|---|---|---|
| Cathode included in | FCC | | coating |
| lithium-ion | (mAh/ | Loading | thickness |
| battery pack | cm²) | (mg/cm²) | (μm) |
| Cathode without pre- | 4.47 | 19.34 | 59 |
| lithiation reagent | | | |
| Pre-lithiated cathode | 4.47 | 17.52 | 52 |
| 116 (with pre- | | | |
| lithiation reagent 101) | | | |

Accordingly, the pre-lithiated cathode 116 may be suitable for assembly into a lithium-ion cell assembly 126. A process of forming the lithium-ion cell assembly 126 may include pairing the pre-lithiated cathode 116 with a corresponding negative electrode 120 (also referred to herein as an “anode”), and interposing the separator 118 therebetween. The anode 120 may include an anode active material. In some examples, the anode active material may include one or more lithium insertion anode materials. For example, the anode active material may include one or more of lithium metal, graphite, graphene, lithium titanium oxide (Li₄Ti₅O₁₂ or LTO), silicon, a silicon oxide (SiOₓ), tin, or a tin oxide (SnOₓ). The separator 118 may serve to separate the pre-lithiated cathode 116 and the anode 120 so as to avoid physical contact therebetween. The separator 118 may have relatively high porosity, relatively excellent stability in an electrolytic solution, and relatively excellent liquid-holding properties. Exemplary materials for the separator 118 may be selected from nonwoven fabrics or porous films made of polyolefins, such as polyethylene and/or polypropylene, or ceramic-coated polymer materials. Other materials may be used for the separator 118 as known to one of ordinary skill in the art.

In other examples, the cathode pre-lithiation slurry manufacturing process 110 may instead be applied to formation of the anode 120, and adaptations and alterations for anodic applications will be readily contemplated by those of at least ordinary skill in the art (for example, by selecting a composition of the pre-lithiation slurry 112 suitable for an anodic configuration).

The pre-lithiated cathode 116, the separator 118, and the anode 120 may be placed within a hermetically-sealed cell housing 122 to form the lithium-ion cell assembly 126. In some examples, the hermetically-sealed cell housing 122 may include a pouch or a can, or any other type of battery housing as known to one of ordinary skill in the art.

The hermetically-sealed cell housing 122 may be filled with an electrolyte 124 to produce a filled lithium-ion cell 128. The electrolyte 124 may support transport of ions between the pre-lithiated cathode 116 and the anode 120, and may be in intimate contact with other components of the filled lithium-ion cell 128. In some examples, the electrolyte 124 may include one or more lithium salts, organic solvents, such as organic carbonates, and additives. The electrolyte 124 may be present throughout the filled lithium-ion cell 128 and may be in physical contact with each of the pre-lithiated cathode 116, the separator 118, and the anode 120.

The filled lithium-ion cell 128 may then undergo cell formation, also referred to as a first charge/discharge cycle, to form the lithium-ion cell 130 (also referred to herein as a “lithium-ion battery,” a “lithium secondary battery,” or a “lithium-ion secondary battery”). The lithium-ion cell 130 may be a fully fabricated and complete battery cell that is ready for use and insertion in the lithium-ion battery pack 132 in conjunction with other similarly fabricated lithium-ion cells 130. The lithium-ion cell 130 may store energy as a chemical potential in the electrodes (e.g., the pre-lithiated cathode 116 and the anode 120) therein, the electrode configured to reversibly convert between chemical and electrical energy via reduction-oxidation reactions.

In this way, the lithium-ion battery pack 132 may be fabricated wherein the cathode pre-lithiation slurry manufacturing process 110 may be employed in forming the pre-lithiated cathode 116 of at least one lithium-ion cell 130 of the lithium-ion battery pack 132. In some examples, the lithium-ion battery pack 132 may include one or more lithium-ion cells 130, and each of the one or more lithium-ion cells 130 may include the pre-lithiated cathode 116 formed via the cathode pre-lithiation slurry manufacturing process 110, the separator 118, the anode 120, and the electrolyte 124. The cathode pre-lithiation slurry manufacturing process 110 may include mixing and milling the pre-lithiation reagent 101 in the solvent 106 to obtain a uniform dispersion of nanoscale particulates of the pre-lithiation reagent 101 and thereby form the pre-lithiation slurry 112. The pre-lithiation slurry 112 may be applied to a cathode substrate (e.g., a porous cathode active material layer disposed on a cathode current collector), dried, and calendered to form the pre-lithiated cathode 116 (e.g., including the pre-lithiation layer formed on the porous cathode active material layer). In some examples, the lithium-ion battery pack 132 may include a plurality of lithium-ion cells 130, where each of the plurality of lithium-ion cells 130 may be of a same configuration.

In some examples, the lithium-ion battery pack 132 may be arranged in a device, and may further be configured for use in the device, where the device may be an electric vehicle, a hybrid-electric vehicle, a cell phone, a smartphone, a global positioning system (GPS), a tablet device, or a computer.

Referring now to FIG. 2A, a schematic cross-section 200 illustrating an exemplary coated cathode structure 201 for use in a lithium-ion battery is shown. Upon formation, the coated cathode structure 201 may be positioned in the lithium-ion battery such that the coated cathode structure 201 may provide power to the lithium-ion battery. In some examples, the lithium-ion battery may be one of a plurality of lithium-ion battery cells in a lithium-ion battery pack, where each of the plurality of lithium-ion battery cells may have a substantially similar configuration to one another. In one example, the coated cathode structure 201 and the lithium-ion battery pack may be the pre-lithiated cathode 116 and the lithium-ion battery pack 132 of FIG. 1, respectively.

The coated cathode structure 201 may include a cathode current collector 202 having a first side 203a and a second side 203b, where the sides 203a, 203b may be opposite to one another with respect to an axis 214 parallel to a smallest dimension of the cathode current collector 202. The cathode current collector 202 may have a cathode active material layer 204 disposed or coated on one of the sides 203a, 203b, the cathode active material layer 204 being in face-sharing contact with the cathode current collector 202. Further, a cathode pre-lithiation layer 206 may be disposed or coated on the cathode active material layer 204 opposite to the cathode current collector 202 with respect to the axis 214 (e.g., opposite to the side 203a or 203b of the cathode current collector 202 on which the cathode active material layer 204 is coated, such that the cathode active material layer 204 is interposed between the cathode current collector 202 and the cathode pre-lithiation layer 206). For example, the cathode active material layer 204 may be coated on the first side 203a of the cathode current collector 202, such that the coated cathode structure 201 may include the cathode current collector 202, the cathode active material layer 204, and the cathode pre-lithiation layer 206 in sequence along the axis 214. Accordingly, the second side 203b of the cathode current collector 202 may face (e.g., be directed towards) or be in face-sharing contact with a separator of the lithium-ion battery (not shown at FIG. 2A). In this way, the separator may not function as a barrier to a lithium-ion channel extending between layers 204, 206 of the coated cathode structure 201 and an electrolyte of the lithium-ion battery (not shown at FIG. 2A). In other examples, each of the sides 203a, 203b of the cathode current collector 202 may include cathode active material layers 204 respectively disposed thereon, with one or both of the cathode active material layers 204 including cathode pre-lithiation layer(s) 206 respectively disposed thereon opposite to the cathode current collector 202 (e.g., the coated cathode structure 201 may include the cathode pre-lithiation layer 206, the cathode active material layer 204, the cathode current collector 202, another cathode active material layer 204, and another cathode pre-lithiation layer 206 in sequence along the axis 214).

The cathode current collector 202 may be a metal sheet or foil such as Cu foil, Ni foil, Al foil, etc., or any other configuration which may conduct electricity and permit current flow therethrough. In one example, a thickness of the cathode current collector 202 may be between 1-20 μm (e.g., about 10 μm). However, it will be appreciated that the thickness of the cathode current collector 202 may vary widely, for example, up to 50 μm.

In some examples, the cathode active material layer 204 may be a slurry-based layer composed of at least a cathode active material, a first conductive additive, and a first binder. In some examples, the cathode active material may be a lithium insertion/deinsertion material. For example, the lithium insertion/deinsertion material may include one or more of NMC, LFP, LMFP, a lithium nickel cobalt aluminum oxide (NCA), a lithium cobalt oxide (LCO), a lithium cobalt phosphate (LCP), a lithium nickel phosphate (LNP), and a lithium manganese phosphate (LMP), and/or any number of other lithium insertion/deinsertion materials known to those of ordinary skill in the art. In an additional or alternative example, the cathode active material may be a lithium mixed metal oxide layered structured material. In some examples, the first conductive additive may be carbonaceous. For example, the first conductive additive may include carbon black, graphene, graphene oxide, and/or CNTs. In some examples, the first binder may include one or more polymers. For example, the first binder may include one or more of PVDF, polyvinylpyrrolidone, poly(ethylene) oxide (PEO) or cross-linked PEO, PTFE, PMMA, PAA, poly(vinylidene fluoride-co-hexafluoropropylene) (PVDF-HFP), one or more conductive polymers such as poly(3,4-ethylenedioxythiophene) (PEDOT), PEDOT polystyrene sulfonate (PEDOT:PSS), and the like, a cellulosic derivative, and a linear, semi-aromatic, or aromatic polyimide (PI).

In some examples, the cathode pre-lithiation layer 206 may be a slurry-based layer composed of at least a cathode pre-lithiation reagent. In some examples, the cathode pre-lithiation reagent may include a lithium compound which may decompose to release Li⁺ ions during pre-lithiation of an anode of the lithium-ion battery (e.g., prior to or during initial charging of the lithium-ion battery). For example, the cathode pre-lithiation reagent may include one or more of Li₃N, Li₂O, Li₂O₂, Li₂S, Li₅FeO₄, Li₂CO₃, Li₂C₂O₄ a Li₂S/M nanocomposite, a LiF/M nanocomposite, and a Li₂O/M nanocomposite, where M is one or more metals.

In some examples, the cathode pre-lithiation reagent may be formed as particulates of a core material having a surface impurity layer formed thereon. For example, the core material may include one or more of Li₂O₂, Li₂O, and Li₂S and the surface impurity layer may include one or more of LiOH and Li₂CO₃. In some examples, the surface impurity layer may be formed (e.g., actively or intentionally formed, rather than formed as an undesired byproduct) during preparation of a slurry for forming the cathode pre-lithiation layer 206 via exposure of the core material to moisture and/or a CO₂-containing atmosphere. In additional or alternative examples, the surface impurity layer may function as an additional (e.g., secondary) cathode pre-lithiation reagent which may decompose to release Li³⁰ ions during pre-lithiation of the anode of the lithium-ion battery. In such examples, the surface impurity layer may decompose within a voltage window, optionally with a catalyst, such as the cathode catalyst discussed hereinbelow.

In some examples, the cathode pre-lithiation layer 206 may further include a cathode catalyst. In some examples, the cathode catalyst may catalyze decomposition of the cathode pre-lithiation reagent during pre-lithiation of the anode of the lithium-ion battery. For example, the cathode catalyst may include an inactive cathode catalyst composed of one or more non-lithiated metal oxides or non-lithiated metal phosphates and/or an active cathode catalyst composed of one or more lithium metal oxides or lithium metal phosphates. In other examples, the cathode pre-lithiation reagent may decompose during practical battery operation voltage windows absent the cathode catalyst.

In some examples, the cathode pre-lithiation layer 206 may further include a second binder. In some examples, the second binder may bind particles of the cathode pre-lithiation reagent to one another, to other particles of the cathode pre-lithiation layer 206, and/or to surfaces of the cathode active material layer 204. For example, the second binder may include one or more of PAN, PEG, PVDF, PTFE, PHFP, PMMA, PAA, poly(4-vinylpyridine), polyvinylpyrrolidone, a CMC derivative, or a copolymer thereof. In other examples, the cathode pre-lithiation layer 206 may sufficiently adhere to the cathode active material layer 204 absent the second binder.

In some examples, the cathode pre-lithiation layer 206 may further include a second conductive additive. In some examples, the second conductive additive may include a carbonaceous material which increases an electronic conductivity of the lithium-ion battery. For example, the second conductive additive may include one or more of carbon black, carbon fibers, carbon nanoparticles, CNTs, graphene oxide, and graphene. In some examples, an amount of the first conductive additive in the cathode active material layer 204 may be reduced or eliminated due to the presence of the second conductive additive in the cathode pre-lithiation layer 206 (which may serve a similar purpose in the lithium-ion battery).

In some examples, the first and second binders may have the same composition (as dependent on compatibility of the first binder with the cathode active material and the second binder with the cathode pre-lithiation reagent). In other examples, the first and second binders may have differing compositions (again, as dependent on compatibility of the first binder with the cathode active material and the second binder with the cathode pre-lithiation reagent). Similarly, in some examples, the first and second conductive additives may have the same composition, while in other examples, the first and second conductive additives may have differing compositions.

In some examples, the cathode pre-lithiation layer 206 may include a non-negligible amount of a secondary cathode active material (e.g., NMC) which may be the same as or different from the cathode active material of the cathode active material layer 204. In one example, the secondary cathode active material may be included in the cathode pre-lithiation layer 206 as the (active) cathode catalyst.

In some examples, the cathode pre-lithiation reagent and each of the cathode catalyst and the second conductive additive (when present) may be in the form of particles, the particles having nanoscale dimensions. As an example, the cathode pre-lithiation reagent particles may have a D50 size of 300 nm or less. As another example, the cathode pre-lithiation reagent particles may have the D50 size of 150 nm or less. Further, when present, the cathode catalyst particles and/or the second conductive additive particles may have a similar size range to the cathode pre-lithiation reagent particles. As an example, the cathode catalyst particles may have a D50 size of 300 nm or less. As another example, the cathode catalyst particles may have the D50 size of 150 nm or less. In some examples, the second binder may be a polymer having a molecular weight from 50 kDa to 5 MDa. In other examples, the second binder may be a polymer having a molecular weight from 500 kDa to 2 MDa.

Respective slurries forming the cathode active material layer 204 and the cathode pre-lithiation layer 206 may be separately prepared and cast in sequence. For example, the cathode active material layer 204 may be formed from a first slurry cast onto the cathode current collector 202 and the cathode pre-lithiation layer 206 may be formed from a second slurry cast onto the cathode active material layer 204, the second slurry being separate and independent, and having a different composition, from the first slurry. In this way, the cathode active material layer 204 and the cathode pre-lithiation layer 206 may be formed as separate slurry-based coatings.

In some examples, the cathode active material layer 204 may include a plurality of pores. Accordingly, when a slurry having sufficiently low viscosity and particles of sufficiently small scale is coated on the cathode active material layer 204, the slurry may seep into or infiltrate those pores nearest a coating interface of the slurry with the cathode active material layer 204 (e.g., where the slurry initially contacts the cathode active material layer 204), thereby improving layer-to-layer adhesion of the cathode active material layer 204 and the (finally-formed) cathode pre-lithiation layer 206 as compared to a relatively high viscosity slurry and/or a relatively low porosity cathode active material layer. During subsequent drying and calendering of the slurry, the slurry may reach a maximum infiltration depth and may cease infiltrating the plurality of pores of the cathode active material layer 204.

As one example, a portion of the cathode pre-lithiation layer 206 may infiltrate the plurality of pores of the cathode active material layer 204 up to a maximum infiltration depth 211. Accordingly, the plurality of pores may include a plurality of filled pores 205a and a plurality of vacant pores 205b, the plurality of filled pores 205a being filled with the infiltrating portion of the cathode pre-lithiation layer 206. Correspondingly, a remaining portion of the cathode pre-lithiation layer 206 not infiltrating the plurality of pores of the cathode active material layer 204 may extend away from the cathode active material layer 204 along the axis 214 up to a maximum extent 210. Further, a remaining portion of the cathode active material layer 204 not infiltrated by the cathode pre-lithiation layer 206 (e.g., including the plurality of vacant pores 205b) may extend away from the cathode pre-lithiation layer 206 along the axis 214 up to a maximum extent 213. In some examples, the maximum extent 213 may be greater than the maximum extent 210.

After each of the cathode active material layer 204 and the cathode pre-lithiation layer 206 are coated and calendered, respective thicknesses along the axis 214 may be determined. The cathode active material layer 204 may have an overall thickness 212 extending between a lower surface or extent 207a of the cathode active material layer 204 interfacing with the cathode current collector 202 (e.g., interfacing with the first side 203a of the cathode current collector 202) and an upper surface or extent 207b of the cathode active material layer 204 interfacing with a bulk of the cathode pre-lithiation layer 206 (e.g., the remaining portion of the cathode pre-lithiation layer 206 not filling the plurality of filled pores 205a) (as used herein, a pair of first and second electrode layers may be described as “interfacing” with one another when the first electrode layer and the second electrode layer physically contact one another and have no intervening components therebetween). For example, the overall thickness 212 of the cathode active material layer 204 may be greater than 50 μm and less than 500 μm. Further, the cathode pre-lithiation layer 206 may have an overall thickness 209 extending between a lower surface or extent 208a of the cathode pre-lithiation layer 206 infiltrating the cathode active material layer 204 and an upper surface or extent 208b of the cathode pre-lithiation layer 206 extending away from the cathode active material layer 204. For example, the overall thickness 209 of the cathode pre-lithiation layer 206 may be greater than 0 μm and less than 200 μm. As another example, the overall thickness 209 of the cathode pre-lithiation layer 206 may be greater than 0 μm and less than 50 μm. As another example, the overall thickness 209 of the cathode pre-lithiation layer 206 may be greater than 0 μm and less than 20 μm. As another example, the overall thickness 209 of the cathode pre-lithiation layer 206 may be greater than 1 μm and less than 10 μm. As another example, the overall thickness 209 of the cathode pre-lithiation layer 206 may be about 10 μm. In some examples, the overall thickness 209 of the cathode pre-lithiation layer 206 may be less than the overall thickness 212 of the cathode active material layer 204.

As shown, the overall thickness 209 of the cathode pre-lithiation layer 206 may be equal to a sum of the maximum extent 210 and the maximum infiltration depth 211. In an exemplary embodiment, the maximum extent 210 and the maximum infiltration depth 211 may independently be greater than 0 μm and less than 200 μm, as restricted or bound by the sum of the maximum extent 210 and the maximum infiltration depth 211 equaling the overall thickness 209 of the cathode pre-lithiation layer 206. For example, when the overall thickness 209 of the cathode pre-lithiation layer 206 is 10 μm, the maximum extent 210 may be 5 μm and the maximum infiltration depth 211 may be 5 μm, or the maximum extent 210 may be 6 μm and the maximum infiltration depth 211 may be 4 μm (but both the maximum extent 210 and the maximum infiltration depth 211 may not sum to greater than 10 μm in such an example). In other examples, the maximum extent 210 and the maximum infiltration depth 211 may independently be greater than 0 μm and less than 50 μm. In other examples, the maximum extent 210 and the maximum infiltration depth 211 may independently be greater than 0 μm and less than 20 μm. In other examples, the maximum extent 210 and the maximum infiltration depth 211 may independently be greater than 1 μm and less than 10 μm. In other examples, the maximum extent 210 and the maximum infiltration depth 211 may independently be about 10 μm.

Similarly, the overall thickness 212 of the cathode active material layer 204 may be equal to a sum of the maximum infiltration depth 211 and the maximum extent 213. Accordingly, in some examples, the maximum extent 213 may be greater than 50 μm and less than 500 μm, as restricted or bound by the overall thickness 212 of the cathode active material layer 204.

The plurality of pores may conform to a number of shapes and sizes. As an example, the plurality of pores may independently have defined shapes, such as circular (e.g., spherical), elliptical (e.g., spheroidal), or irregular, in any combination thereof among the plurality of pores. As another example, an average (e.g., D50) size of the plurality of pores may be between 1 μm and 10 μm in diameter. Accordingly, in some examples, the plurality of pores may be larger in average size than the particles of each of the cathode pre-lithiation reagent, the cathode catalyst, the second binder, and the conductive additive. Further, in some examples, pairs of the plurality of pores may be separated by an average distance of between 1 μm and 10 μm. In other examples, at least some of the plurality of pores may be connected to, or overlap with, one another. In one example, the plurality of pores may independently have defined shapes (e.g., substantially circular, elliptical, or irregular shapes), the plurality of pores may have a D50 size of about 3 μm, and each of the plurality of pores may be separated from each other of the plurality of pores by an average distance of about 5 μm.

In some examples, the cathode pre-lithiation layer 206 may infiltrate each of the plurality of pores interposed between the bulk of the cathode pre-lithiation layer 206 and the lower extent 208a and may therefore be evenly distributed throughout the plurality of pores up to the maximum infiltration depth 211. However, in other examples, and as shown, at least some of the plurality of vacant pores 205b may remain between the bulk of the cathode pre-lithiation layer 206 and the lower extent 208a. Accordingly, in such examples, the cathode pre-lithiation layer 206 may not be evenly distributed among the plurality of pores interposed between the bulk of the cathode pre-lithiation layer 206 and the lower extent 208a.

In the coated cathode structure 201, the slurry forming the cathode pre-lithiation layer 206 may have a viscosity between 10 and 5000 cP at a shear rate of 100 s⁻¹ and the cathode active material layer 204 may have a porosity of greater than 30%. In other examples, cathode pre-lithiation layer 206 may have a viscosity between 100 and 5000 cP at a shear rate of 100 s⁻¹. In other examples, the porosity of the cathode active material layer 204 may be greater than 40%. In other examples, the porosity of the cathode active material layer 204 may be between 30% and 50%, such that the slurry may partially infiltrate the plurality of pores of the cathode active material layer 204 during a manufacturing process of the coated cathode structure 201. However, and as discussed in detail below with reference to FIGS. 2B and 2C, less or more of the cathode pre-lithiation layer 206 may infiltrate the plurality of pores of the cathode active material layer 204 as the viscosity of the slurry forming the cathode pre-lithiation layer 206 and the porosity of the cathode active material layer 204 are adjusted.

As an example, and referring now to FIG. 2B, a schematic cross-section 220 illustrating an exemplary coated cathode structure 221 for use in a lithium-ion battery is shown. Upon formation, the coated cathode structure 221 may be positioned in the lithium-ion battery such that the coated cathode structure 221 may provide power to the lithium-ion battery. In some examples, the lithium-ion battery may be one of a plurality of lithium-ion battery cells in a lithium-ion battery pack, where each of the plurality of lithium-ion battery cells may have a substantially similar configuration to one another. In one example, the coated cathode structure 221 and the lithium-ion battery pack may be the pre-lithiated cathode 116 and the lithium-ion battery pack 132 of FIG. 1, respectively.

Structural features of the coated cathode structure 221 may be considered substantially similar to, or the same as, the coated cathode structure 201 of FIG. 2A, excepting as discussed below. The coated cathode structure 221 may include a cathode current collector 222 having a first side 223a opposite to a second side 223b with respect to an axis 234 parallel to a smallest dimension of the cathode current collector 222, a cathode active material layer 224 disposed on one or both of the sides 223a, 223b, and a cathode pre-lithiation layer 226 disposed on the cathode active material layer 224 opposite to the cathode current collector 222 with respect to the axis 234, such that the cathode active material layer 224 is interposed between the cathode current collector 222 and the cathode pre-lithiation layer 226. Further, the cathode active material layer 224 and the cathode pre-lithiation layer 226 may be formed as separate slurry-based coatings, with the cathode active material layer 224 including a plurality of pores, the plurality of pores including a plurality of filled pores 225a (infiltrated by the cathode pre-lithiation layer 226) and a plurality of vacant pores 225b. Accordingly, and as should be readily apparent, components of the coated cathode structure 221 may be similarly numbered to components of the coated cathode structure 201 of FIG. 2A (e.g., the cathode current collector 222, the cathode active material layer 224, the cathode pre-lithiation layer 226, etc. may be substantially similar to, or the same as, the cathode current collector 202, the cathode active material layer 204, the cathode pre-lithiation layer 206, etc., respectively, excepting as discussed below).

An infiltrating portion of the cathode pre-lithiation layer 226 may infiltrate the cathode active material layer 224 to a maximum infiltration depth 231 (e.g., from an upper surface or extent 227b of the cathode active material layer 224 to a lower surface or extent 228a of the cathode pre-lithiation layer 226) and a remaining portion of the cathode pre-lithiation layer 226 may extend away from the cathode active material layer 224 along the axis 234 to a maximum extent 230 (e.g., from the upper surface or extent 227b of the cathode active material layer 224 to an upper surface or extent 228b of the cathode pre-lithiation layer 226). Accordingly, the cathode pre-lithiation layer 226 may have an overall thickness 229 equal to a sum of the maximum extent 230 and the maximum infiltration depth 231. Further, a portion of the cathode active material layer 224 not being infiltrated by the cathode pre-lithiation layer 226 may extend away from the cathode pre-lithiation layer 226 along the axis 234 to a maximum extent 233 (e.g., from the lower surface or extent 228a of the cathode pre-lithiation layer 226 to a lower surface or extent 227a of the cathode active material layer 224). Accordingly, the cathode active material layer 224 may have an overall thickness 232 equal to a sum of the maximum infiltration depth 231 and the maximum extent 233.

However, the cathode active material layer 224 may have a lower porosity than the cathode active material layer 204 of FIG. 2A. For example, the porosity of the cathode active material layer 224 may be less than 30% (additionally or alternatively, a D50 size of the plurality of pores of may be less than 1 μm and/or an average distance between pairs of the plurality of pores may be greater than 5 μm). Further, the cathode pre-lithiation layer 226 may be formed from a slurry having a higher viscosity than the slurry forming the cathode pre-lithiation layer 206 of FIG. 2A. For example, the viscosity of the cathode pre-lithiation layer 226 may be greater than 5000 cP at a shear rate of 100 s⁻¹. Accordingly, during formation of the cathode pre-lithiation layer 226, the slurry may infiltrate the plurality of pores of the cathode active material layer 224 to a lesser extent than a slurry having a lower viscosity (such as the slurry forming the cathode pre-lithiation layer 206 of FIG. 2A) and a cathode active material layer having a higher porosity (such as the cathode active material layer 204 of FIG. 2A). Thus, the maximum infiltration depth 231 may be less than the maximum infiltration depth 211 of FIG. 2A, the maximum extent 230 may be greater than the maximum extent 210 of FIG. 2A, and the maximum extent 233 may be greater than the maximum extent 213 of FIG. 2A.

As another example, and referring now to FIG. 2C, a schematic cross-section 240 illustrating an exemplary coated cathode structure 241 for use in a lithium-ion battery is shown. Upon formation, the coated cathode structure 241 may be positioned in the lithium-ion battery such that the coated cathode structure 241 may provide power to the lithium-ion battery. In some examples, the lithium-ion battery may be one of a plurality of lithium-ion battery cells in a lithium-ion battery pack, where each of the plurality of lithium-ion battery cells may have a substantially similar configuration to one another. In one example, the coated cathode structure 241 and the lithium-ion battery pack may be the pre-lithiated cathode 116 and the lithium-ion battery pack 132 of FIG. 1, respectively.

Structural features of the coated cathode structure 241 may be considered substantially similar to, or the same as, the coated cathode structure 201 of FIG. 2A, excepting as discussed below. The coated cathode structure 241 may include a cathode current collector 242 having a first side 243a opposite to a second side 243b with respect to an axis 254 parallel to smallest dimension of the cathode current collector 242, a cathode active material layer 244 disposed on one or both of the sides 243a, 243b, and a cathode pre-lithiation layer 246 disposed on the cathode active material layer 244 opposite to the cathode current collector 242 with respect to the axis 254, such that the cathode active material layer 244 is interposed between the cathode current collector 242 and the cathode pre-lithiation layer 246. Moreover, the cathode active material layer 244 and the cathode pre-lithiation layer 246 may be formed as separate slurry-based coatings, with the cathode active material layer 244 including a plurality of pores, the plurality of pores including a plurality of filled pores 245a (infiltrated by the cathode pre-lithiation layer 246) and a plurality of vacant pores 245b. Accordingly, and as should be readily apparent, components of the coated cathode structure 241 may be similarly numbered to components of the coated cathode structure 201 of FIG. 2A (e.g., the cathode current collector 242, the cathode active material layer 244, the cathode pre-lithiation layer 246, etc. may be substantially similar to, or the same as, the cathode current collector 202, the cathode active material layer 204, the cathode pre-lithiation layer 206, etc., respectively, excepting as discussed below).

An infiltrating portion of the cathode pre-lithiation layer 246 may infiltrate the cathode active material layer 244 to a maximum infiltration depth 251 (e.g., from an upper surface or extent 247b of the cathode active material layer 244 to a lower surface or extent 248a of the cathode pre-lithiation layer 246) and a remaining portion of the cathode pre-lithiation layer 246 may extend away from the cathode active material layer 244 along the axis 254 to a maximum extent 250 (e.g., from the upper surface or extent 247b of the cathode active material layer 244 to an upper surface or extent 248b of the cathode pre-lithiation layer 246). Accordingly, the cathode pre-lithiation layer 246 may have an overall thickness 249 equal to a sum of the maximum extent 250 and the maximum infiltration depth 251. Further, a portion of the cathode active material layer 244 not being infiltrated by the cathode pre-lithiation layer 246 may extend away from the cathode pre-lithiation layer 246 along the axis 254 to a maximum extent 253 (e.g., from the lower surface or extent 248a of the cathode pre-lithiation layer 246 to a lower surface or extent 247a of the cathode active material layer 244). Accordingly, the cathode active material layer 244 may have an overall thickness 252 equal to a sum of the maximum infiltration depth 251 and the maximum extent 253.

However, the cathode active material layer 244 may have a higher porosity than the cathode active material layer 204 of FIG. 2A. For example, the porosity of the cathode active material layer 244 may be greater than 40% (additionally or alternatively, a D50 size of the plurality of pores of may be greater than 5 μm and/or an average distance between pairs of the plurality of pores may be less than 1 μm). Further, the cathode pre-lithiation layer 246 may be formed from a slurry having a lower viscosity than the slurry forming the cathode pre-lithiation layer 206 of FIG. 2A. For example, the viscosity of the cathode pre-lithiation layer 246 may be less than 10 cP at a shear rate of 100 s⁻¹. Accordingly, during formation of the cathode pre-lithiation layer 246, the slurry may infiltrate the plurality of pores of the cathode active material layer 244 to a greater extent than a slurry having a higher viscosity (such as the slurry forming the cathode pre-lithiation layer 206 of FIG. 2A) and a cathode active material layer having a lower porosity (such as the cathode active material layer 204 of FIG. 2A). Thus, the maximum infiltration depth 251 may be greater than the maximum infiltration depth 211 of FIG. 2A, the maximum extent 250 may be less than the maximum extent 210 of FIG. 2A, and the maximum extent 253 may be less than the maximum extent 213 of FIG. 2A.

Referring now to FIG. 2D, a schematic cross-section 260 illustrating an exemplary coated cathode structure 261 for use in a lithium-ion battery is shown. Upon formation, the coated cathode structure 261 may be positioned in the lithium-ion battery such that the coated cathode structure 261 may provide power to the lithium-ion battery. In some examples, the lithium-ion battery may be one of a plurality of lithium-ion battery cells in a lithium-ion battery pack, where each of the plurality of lithium-ion battery cells may have a substantially similar configuration to one another. In one example, the coated cathode structure 261 and the lithium-ion battery pack may be the pre-lithiated cathode 116 and the lithium-ion battery pack 132 of FIG. 1, respectively.

Structural features of the coated cathode structure 261 may be considered substantially similar to, or the same as, the coated cathode structure 201 of FIG. 2A, excepting as discussed below. The coated cathode structure 261 may include a cathode current collector 262 having a first side 263a opposite to a second side 263b with respect to an axis 234 parallel to a smallest dimension of the cathode current collector 262. The coated cathode structure 261 may further include a cathode active material layer 264 and a cathode pre-lithiation layer 266. The cathode active material layer 264 and the cathode pre-lithiation layer 266 may be formed as separate slurry-based coatings, with the cathode active material layer 264 including a plurality of pores, the plurality of pores including a plurality of filled pores 265a (infiltrated by the cathode pre-lithiation layer 266) and a plurality of vacant pores 265b. Accordingly, and as should be readily apparent, components of the coated cathode structure 261 may be similarly numbered to components of the coated cathode structure 201 of FIG. 2A (e.g., the cathode current collector 262, the cathode active material layer 264, the cathode pre-lithiation layer 266, etc. may be substantially similar to, or the same as, the cathode current collector 202, the cathode active material layer 204, the cathode pre-lithiation layer 206, etc., respectively, excepting as discussed below).

However, and in contrast to the coated cathode structure 201 of FIG. 2A (as well as the coated cathode structures 221 and 241 of FIGS. 2B and 2C, respectively), in the coated cathode structure 261, the cathode current collector 262 may have the cathode pre-lithiation layer 266 disposed or coated on one of the sides 263a, 263b, the cathode pre-lithiation layer 266 being in face-sharing contact with the cathode current collector 262. Accordingly, the cathode active material layer 264 may be disposed or coated on the cathode pre-lithiation layer 266 opposite to the cathode current collector 262 with respect to the axis 274 (e.g., opposite to the side(s) 263a and/or 263b of the cathode current collector 262 on which the cathode pre-lithiation layer 266 is coated, such that the cathode pre-lithiation layer 266 is interposed between the cathode current collector 262 and the cathode active material layer 264). For example, the cathode pre-lithiation layer 266 may be coated on the first side 263a of the cathode current collector 262, such that the coated cathode structure 261 may include the cathode current collector 262, the cathode pre-lithiation layer 266, and the cathode active material layer 264 in sequence along the axis 274. In other examples, each of the sides 263a, 263b of the cathode current collector 262 may include cathode pre-lithiation layers 266 respectively disposed thereon, with one or both of the cathode pre-lithiation layers 266 including cathode active material layer(s) 264 respectively disposed thereon opposite to the cathode current collector 262 (e.g., the coated cathode structure 261 may include the cathode active material layer 264, the cathode pre-lithiation layer 266, the cathode current collector 262, another cathode pre-lithiation layer 266, and another cathode active material layer 264 in sequence along the axis 274).

An infiltrating portion of the cathode pre-lithiation layer 266 may infiltrate the cathode active material layer 264 to a maximum infiltration depth 271 (e.g., from a lower surface or extent 267a of the cathode active material layer 264 to an upper surface or extent 268b of the cathode pre-lithiation layer 266) and a remaining portion of the cathode pre-lithiation layer 266 may extend away from the cathode active material layer 264 along the axis 274 to a maximum extent 270 (e.g., from the lower surface or extent 267a of the cathode active material layer 264 to a lower surface or extent 268a of the cathode pre-lithiation layer 266). Accordingly, the cathode pre-lithiation layer 266 may have an overall thickness 269 equal to a sum of the maximum extent 270 and the maximum infiltration depth 271. Further, a portion of the cathode active material layer 264 not being infiltrated by the cathode pre-lithiation layer 266 may extend away from the cathode pre-lithiation layer 266 along the axis 274 to a maximum extent 273 (e.g., from the upper surface or extent 268b of the cathode pre-lithiation layer 266 to an upper surface or extent 267b of the cathode active material layer 264). Accordingly, the cathode active material layer 264 may have an overall thickness 272 equal to a sum of the maximum infiltration depth 271 and the maximum extent 273.

It will be appreciated that the aspects of the coated cathode structures 201, 221, 241, and 261 described in detail above with reference to FIGS. 2A-2D are not mutually exclusive and that such aspects may be added, removed, substituted, or combined according to a given application. For example, a coated cathode structure may include a cathode current collector coated on opposite sides thereof with differing coating configurations (e.g., maximum infiltration depths, maximum extents, overall thicknesses, and/or relative layer orderings of cathode active material and cathode pre-lithiation layers may differ between the coated sides of the cathode current collector).

Referring now to FIG. 3A, an SEM image 300 depicting a cathode pre-lithiation layer 302 disposed on a cathode active material layer 306 included in a pre-lithiated cathode of a lithium-ion battery is shown. In some examples, the lithium-ion battery may be one of a plurality of lithium-ion battery cells in a lithium-ion battery pack, where each of the plurality of lithium-ion battery cells may have a substantially similar configuration to one another. Accordingly, in one example, the lithium-ion battery pack may be the lithium-ion battery pack 132 of FIG. 1. A reference scale 310 is provided for approximating dimensions of the SEM image 300 and features depicted therein. For example, a largest dimension of the SEM image 300 is less than 1 mm.

A slurry used to form the cathode pre-lithiation layer 302 may be processed with suboptimal processing parameters, steps, or step orderings, resulting in a relatively high viscosity of greater than 5000 cP at a shear rate of 100 s⁻¹ and thus improper or incomplete coating of the cathode active material layer 306 by the cathode pre-lithiation layer 302. For example, the suboptimal processing parameters may include an improper or otherwise undesirable slurry formulation and/or an improper or otherwise undesirable wet gap during casting, drying, and calendering of the slurry. As shown, due to the suboptimal processing of the slurry forming the cathode pre-lithiation layer 302, the cathode pre-lithiation layer 302 may not achieve sufficient layer-to-layer adhesion with the cathode active material layer 306 and may subsequently delaminate from the cathode active material layer 306 in an operating environment of the lithium-ion battery. Accordingly, and as further shown, primary and secondary particles 308 of the cathode active material included in the cathode active material layer 306 may be exposed to an electrolyte included in the lithium-ion battery and extensive cracking 304 may result during formation of the cathode pre-lithiation layer 302 or during subsequent delamination thereof, which may lead to further delamination as charge/discharge cycling continues.

An electrochemical performance of the lithium-ion battery may be significantly compromised by such delamination relative to a lithium-ion battery including a sufficiently adhered cathode pre-lithiation layer (such as described in detail below with reference to FIG. 3B). For example, an FCC of the lithium-ion battery may be 333.8±14.1 mAh/g and an FDC of the lithium-ion battery may be 178.7±16.8 mAh/g (as compared to an expected FDC of 203 mAh/g), such that an FCE of the lithium-ion battery may be 53.8±6.9%. Further, as indicated by the relatively large variance of each of the FCC, the FDC, and the FCE, cell-to-cell variation may be correspondingly large (e.g., less uniform) when such delamination occurs.

Referring now to FIG. 3B, an SEM image 350 depicting a cathode pre-lithiation layer 352 disposed on a cathode active material layer (substantially completely covered by the cathode pre-lithiation layer 352 and thus not visible in the SEM image 350) included in a pre-lithiated cathode of a lithium-ion battery is shown. In some examples, the lithium-ion battery may be one of a plurality of lithium-ion battery cells in a lithium-ion battery pack, where each of the plurality of lithium-ion battery cells may have a substantially similar configuration to one another. Accordingly, in one example, the lithium-ion battery pack may be the lithium-ion battery pack 132 of FIG. 1. A reference scale 360 is provided for approximating dimensions of the SEM image 350 and features depicted therein. For example, a largest dimension of the SEM image 350 is less than 1 mm.

A slurry used to form the cathode pre-lithiation layer 352 may be processed with optimal processing parameters, steps, or step orderings, resulting in a viscosity of greater than 10 cP and less than 5000 cP at a shear rate of 100 s⁻¹ and thus substantially complete coating of the cathode active material layer by the cathode pre-lithiation layer 352. For example, the optimal processing parameters may include a desirable slurry formulation and/or a desirable wet gap during casting, drying, and calendering of the slurry. As shown, due to the optimal processing of the slurry forming the cathode pre-lithiation layer 352, the cathode pre-lithiation layer 352 may achieve sufficient layer-to-layer adhesion with the cathode active material layer. Accordingly, and as further shown, though cracking 354 may result during formation of the cathode pre-lithiation layer 352 or during subsequent operation of the lithium-ion battery, the cracking 354 may be less extensive than an insufficiently adhered cathode pre-lithiation layer (such as the cathode pre-lithiation layer 302 of FIG. 3A) and the cathode pre-lithiation layer 352 may be substantially smooth overall.

An electrochemical performance of the lithium-ion battery may further be improved relative to a lithium-ion battery including the insufficiently adhered cathode pre-lithiation layer (such as described in detail above with reference to FIG. 3A). For example, an FCC of the lithium-ion battery may be 280.8±2.5 mAh/g and an FDC of the lithium-ion battery may be 227.4±2.1 mAh/g (as compared to an expected FDC of 228 mAh/g), such that an FCE of the lithium-ion battery may be 81.0±1.0%. Further, as indicated by the relatively small variance of each of the FCC, the FDC, and the FCE, cell-to-cell variation may be correspondingly small (e.g., more uniform) when the cathode pre-lithiation layer 352 is sufficiently adhered. In this way, and as is readily apparent from comparing the SEM images of FIGS. 3A and 3B, judicious selection of slurry processing parameters, steps, and step orderings in achieving sufficient layer-to-layer adhesion in forming a pre-lithiated cathode for use in a lithium-ion battery may significantly impact electrochemical performance of the lithium-ion battery.

Referring now to FIG. 4, a flow chart of a method 400 is depicted for forming a pre-lithiated cathode including a slurry-based cathode pre-lithiation layer. In one example, a slurry for forming the cathode pre-lithiation layer may be processed so as to obtain a uniform dispersion of a nanoscale cathode pre-lithiation reagent throughout and a viscosity of 10 to 5000 cP at a shear rate of 100 s⁻¹. The (low viscosity) slurry may be cast onto a high porosity cathode active material layer so as to attain sufficient layer-to-layer adhesion for practical battery operation voltage windows and thereby maintain relatively low interfacial impedance and substantially avoid delamination of the cathode pre-lithiation layer. Further, by limiting an overall thickness of the cathode pre-lithiation layer, impedance therethrough may be correspondingly limited (in addition to further limiting delamination of the cathode pre-lithiation layer). In this way, the pre-lithiated cathode may have relatively high structural integrity and, when configured to provide power to a lithium-ion battery, may provide sufficient Li⁺ ion inventory during pre-lithiation of an anode included in the lithium-ion battery such that an overall electrochemical performance of the lithium-ion battery may be improved (e.g., relative to a pre-lithiated cathode having relatively low structural integrity or a cathode incapable of providing additional Li⁺ ions to the anode beyond Li⁺ ions deintercalated from a cathode active material therein).

It will be appreciated that method 400 may be described in relation to the components described in detail above with reference to FIGS. 1-2D. For example, the pre-lithiated cathode may be the pre-lithiated cathode 116 of FIG. 1 or any one of the coated cathode structures 201, 221, 241, or 261 of FIGS. 2A-2D. Further, though the embodiments described herein are directed to formation of pre-lithiated cathodes, it will be appreciated that at least some of the embodiments described herein may be adapted to formation of anodes. For example, method 400 may be readily adapted or altered to manufacture of a slurry for forming a pre-lithiated anode.

At 402, method 400 includes forming a homogeneous mixture including a cathode pre-lithiation reagent. In some examples, the cathode pre-lithiation reagent may be milled prior to inclusion in the homogeneous mixture (however, milling of the homogeneous mixture at 408, as described below, may mill the cathode pre-lithiation reagent further). At 404, method 400 includes forming the homogeneous mixture which may include uniformly dispersing the cathode pre-lithiation reagent in a non-aqueous solvent. In some examples, the cathode pre-lithiation reagent may be selected from Li₃N, Li₂O, Li₂O₂, Li₂S, Li₂CO₃, Li₂C₂O₄, Li₅FeO₄, a Li₂S/M nanocomposite, a LiF/M nanocomposite, a Li₂O/M nanocomposite, or any combination of the preceding compounds, where M is one or more metals, and the non-aqueous solvent may be selected from DMF, NMP, DMAc, DMSO, MeCN, THF, toluene, or any combination of the preceding compounds. In some examples, the cathode pre-lithiation reagent may be formed as a core material with a surface impurity layer formed thereon. In one such example, the core material may include one or more of Li₂O₂, Li₂O, and Li₂S and the surface impurity layer may include one or more of LiOH and Li₂CO₃.

Further, at 406, one or more additives may be uniformly dispersed in the non-aqueous solvent, the one or more additives including one or more of a cathode catalyst (e.g., for catalyzing decomposition of the cathode pre-lithiation reagent), a binder (e.g., for binding various components of the homogeneous mixture to one another), and a conductive carbon additive (e.g., for improving electronic conductivity of the lithium-ion battery). In some examples, the cathode catalyst may be selected from an inactive cathode catalyst composed of one or more non-lithiated metal oxides or non-lithiated metal phosphates and/or an active cathode catalyst composed of one or more lithium metal oxides or lithium metal phosphates. In additional or alternative examples, the binder may be selected from PAN, PEG, PVDF, PTFE, PHFP, PMMA, PAA, poly(4-vinylpyridine), polyvinylpyrrolidone, a CMC derivative, any copolymer of the preceding compounds, or any combination of the preceding compounds. In additional or alternative examples, the conductive carbon additive may be selected from carbon black, carbon fibers, carbon nanoparticles, CNTs, graphene oxide, graphene, or any combination of the preceding compounds.

As shown in FIG. 4, 406 is depicted in dashing, indicating that inclusion of the one or more additives in the homogeneous mixture is optional. As an example, the cathode pre-lithiation reagent may be selected to decompose absent the cathode catalyst. As another example, the binder may be omitted as the finally-formed cathode pre-lithiation layer may adhere to a porous cathode active material layer via infiltration alone (as discussed below).

By mixing the cathode pre-lithiation reagent and optionally the one or more additives in the non-aqueous solvent for a sufficient duration (e.g., 24 hours), the uniform dispersion may be realized and the homogeneous mixture may be formed. Further, an overall composition and a solids content of the homogeneous mixture may be selected such that a desired viscosity of the finally-formed slurry may be realized. As an example, the overall composition of the homogeneous mixture may include one or more cathode pre-lithiation reagents, one or more cathode catalysts, the conductive carbon additive, and the binder and the solids content of the homogeneous mixture may be between 10-70% so as to achieve a desired viscosity of 10 to 5000 cP at a shear rate of 100 s⁻¹.

At 408, method 400 includes milling the homogeneous mixture to form the slurry. In some examples, the homogeneous mixture may be milled for a sufficient duration (e.g., 24 hours) such that the cathode pre-lithiation reagent and any other particles therein are reduced to particles having a D50 size of 300 nm or less. By reducing the cathode pre-lithiation reagent to nanoscale dimensions in this way, in combination with the cathode pre-lithiation reagent being uniformly dispersed, greater structural stability of the finally-formed pre-lithiated cathode (e.g., via increased physical contact of various components in the slurry and elsewhere in the pre-lithiated cathode with the binder) may be realized, in addition to achieving greater pre-lithiating activity in examples wherein the cathode catalyst is included in the homogeneous mixture (e.g., via increased contact of the cathode pre-lithiation reagent with the cathode catalyst).

At 410, method 400 includes casting the slurry onto a cathode substrate to form a slurry-coated cathode substrate. In some examples, the cathode substrate may include a porous cathode active material layer disposed on a cathode current collector. In one example, the porous cathode active material layer may be formed by casting an additional, separate slurry onto the cathode current collector prior to casting the slurry onto the cathode substrate at 410.

In some examples, a porosity of the porous cathode active material layer may be greater than 30% or greater than 40% (e.g., between 30% and 50%), wherein pores of the porous cathode active material layer may have an average size of between 1 μm and 10 μm in diameter. In this way, the porosity of the porous cathode active material layer may be tailored so as to permit at least partial infiltration of the slurry into the porous cathode active material layer and thereby achieve sufficient layer-to-layer adhesion between the finally-formed cathode pre-lithiation layer and the porous cathode active material layer. As an example, the porosity of the porous cathode active material layer may be increased with increasing viscosity of the slurry during formation thereof and the porosity of the porous cathode active material layer may be decreased with decreasing viscosity of the slurry during formation thereof. As another example, the porosity of the porous cathode active material may be increased with increasing D50 size of particles in the slurry during formation thereof and the porosity of the porous cathode active material may be decreased with decreasing D50 size of particles in the slurry during formation thereof. In some examples, the porous cathode active material layer may be wet (e.g., not completely dried) prior to the slurry being cast thereon. In such examples, the porosity of the porous cathode active material layer may be increased when the slurry-coated cathode substrate is dried at 412 (as discussed below). In other examples, the porous cathode active material layer may be substantially dry prior to the slurry being cast thereon.

At 412, method 400 includes drying the slurry-coated cathode substrate. In some examples, the slurry-coated cathode substrate may be dried at a temperature of between 20 and 300° C. (e.g., until the non-aqueous solvent is substantially evaporated). In examples wherein the porous cathode active material layer is wet or partially dried prior to drying of the slurry-coated substrate at 412, the porous cathode active material layer may be dried simultaneously with the slurry and the layer-to-layer adhesion between the finally-formed cathode pre-lithiation layer and the porous cathode active material layer may be further improved. In additional or alternative examples, the porous cathode active material layer may be at least partially dried at a similar temperature (e.g., between 20 to 300° C.) prior to casting of the slurry thereon.

At 414, method 400 includes calendering the dried slurry-coated cathode substrate. Thus, a pre-lithiated cathode for a lithium-ion battery may be formed, the pre-lithiated cathode including a cathode pre-lithiation layer which is both structurally stable and decomposes prior to or during initial charging of the lithium-ion battery to release excess Li⁺ ions to an anode of the lithium-ion battery.

Referring now to FIGS. 5A-5C, plots 500, 520, and 540 are respectively shown, depicting pairwise relationships between a viscosity of a cathode pre-lithiation slurry, a porosity of a porous cathode active material layer, and an infiltration depth of a cathode pre-lithiation layer formed from the cathode pre-lithiation slurry into the porous cathode active material layer (e.g., following casting, drying, and calendering of the cathode pre-lithiation slurry). In some examples, each of the cathode pre-lithiation layer and the porous cathode active material layer may be included in a pre-lithiated cathode of a lithium-ion battery. In certain examples, the lithium-ion battery may be one of a plurality of lithium-ion battery cells in a lithium-ion battery pack, where each of the plurality of lithium-ion battery cells may have a substantially similar configuration to one another. Accordingly, in one example, the lithium-ion battery pack may be the lithium-ion battery pack 132 of FIG. 1.

Referring now to FIG. 5A, in plot 500, an abscissa represents the viscosity of the cathode pre-lithiation slurry and an ordinate represents the infiltration depth of the cathode pre-lithiation layer into the porous cathode active material layer. As indicated by a negatively sloping curve 502, as the viscosity of the cathode pre-lithiation slurry decreases, the infiltration depth of the cathode pre-lithiation layer into the porous cathode active material layer increases. Correspondingly, as the viscosity of the cathode pre-lithiation slurry increases, the infiltration depth of the cathode pre-lithiation layer into the porous cathode active material layer decreases. In this way, the infiltration depth of the cathode pre-lithiation layer into the porous cathode active material layer (for a fixed porosity of the porous cathode active material layer) may be modulated by tailoring the viscosity of the cathode pre-lithiation slurry used in forming the cathode pre-lithiation layer.

Referring now to FIG. 5B, in plot 520, an abscissa represents the porosity of the porous cathode active material layer and an ordinate represents the infiltration depth of the cathode pre-lithiation layer into the porous cathode active material layer. As indicated by a positively sloping curve 522, as the porosity of the porous cathode active material layer decreases, the infiltration depth of the cathode pre-lithiation layer into the porous cathode active material layer decreases. Correspondingly, as the porosity of the porous cathode active material layer increases, the infiltration depth of the cathode pre-lithiation layer into the porous cathode active material layer increases. In this way, the infiltration depth of the cathode pre-lithiation layer into the porous cathode active material layer (for a fixed viscosity of the cathode pre-lithiation slurry used in forming the cathode pre-lithiation layer) may be modulated by tailoring the porosity of the porous cathode active material layer.

Accordingly, to achieve a desirable infiltration depth of the cathode pre-lithiation layer into the porous cathode active material layer, the viscosity of the cathode pre-lithiation slurry used in forming the cathode pre-lithiation layer and the porosity of the porous cathode active material layer may be adjusted in tandem. For example, a viscosity value may exist for each porosity value (and vice versa) for a fixed infiltration depth value. Referring now to FIG. 5C, plot 540 illustrates such a relationship. An abscissa represents the porosity of the porous cathode active material layer and an ordinate represents a viscosity of the cathode pre-lithiation slurry utilized to achieve a fixed infiltration depth of the cathode pre-lithiation layer into the porous cathode active material layer. As indicated by a positively sloping curve 542, as the porosity of the porous cathode active material layer decreases, the viscosity of the cathode pre-lithiation slurry utilized to achieve the fixed infiltration depth decreases. Correspondingly, as the porosity of the porous cathode active material layer increases, the viscosity of the cathode pre-lithiation slurry utilized to achieve the fixed infiltration depth increases. In this way, for a given infiltration depth of the cathode pre-lithiation layer into the porous cathode active material layer, a set of porosity and viscosity values may be determined for the porous cathode active material layer and the cathode pre-lithiation slurry, respectively.

Referring now to FIG. 6, a plot 600 depicting capacity retentions of a first exemplary lithium-ion battery including a pre-lithiated cathode and a second exemplary lithium-ion battery including a cathode without a pre-lithiation reagent over 100 cycles is shown. In some examples, the first exemplary lithium-ion battery may be one of a plurality of lithium-ion battery cells in a lithium-ion battery pack, where each of the plurality of lithium-ion battery cells may have a substantially similar configuration to one another. Accordingly, in one example, the lithium-ion battery pack may be the lithium-ion battery pack 132 of FIG. 1. In such an example, the second exemplary lithium-ion battery may be constructed in a substantially similar fashion and similarly included in a lithium-ion battery pack, excepting that no pre-lithiation reagent is included during formation of the cathode (e.g., no cathode pre-lithiation layer is formed).

As shown in plot 600, an abscissa represents a number of cycles completed and an ordinate represents normalized capacity retention values. Cycling of the first and second exemplary lithium-ion battery packs may be conducted under substantially equivalent conditions, e.g., at 45° C., between 2.8 V and 4.3 V, and at a C-rate of C/3. A curve 602 indicates the capacity retention of the second exemplary lithium-ion battery and a curve 604 indicates the capacity retention of the first exemplary lithium-ion battery, the capacity retention of the first exemplary lithium-ion battery being better maintained over extended cycling than the capacity retention of the second exemplary lithium-ion battery. For example, curve 604 indicates the capacity retention of the first exemplary lithium-ion battery pack stays above 90% over 120 battery cycles whereas curve 602 indicates the second exemplary lithium-ion battery capacity retention decreases under 90% by 60 cycles and may be substantially 80% at the end of 120 battery cycles. In this way, by including a pre-lithiated cathode having cathode pre-lithiation and cathode active material layers coated using separate slurries in a lithium-ion battery, improved cycling performance may be realized relative to a lithium-ion battery without any such cathode pre-lithiation layer (or pre-lithiation reagent whatsoever).

Referring now to FIG. 7, an SEM image 700 depicting a cross-section of a porous cathode active material layer 704 disposed on a substrate 702 including in a pre-lithiated cathode of a lithium-ion battery is shown. In some examples, the lithium-ion battery may be one of a plurality of lithium-ion battery cells in a lithium-ion battery pack, where each of the plurality of lithium-ion battery cells may have a substantially similar configuration to one another. Accordingly, in one example, the lithium-ion battery pack may be the lithium-ion battery pack 132 of FIG. 1. Further, in such an example, the substrate 702 may be a conductive substrate. A reference scale 710 is provided for approximating dimensions of the SEM image 700 and features depicted therein. For example, a largest dimension of the SEM image is less than 100 μm.

A plurality of pores 706 having a range of shapes and sizes are shown in the SEM image 700. The plurality of pores 706 are shown having substantially circular (e.g., spherical), elliptical (e.g., spheroidal), and irregular shapes, a largest dimension of between ˜1 μm and ˜25 μm, and an average size of between ˜1 μm and ˜10 μm. Further, a minimum distance between nearest neighbor pairs of adjacent pores 706 is shown as being between ˜1 μm and ˜15 μm and an average distance between nearest neighbor pairs of pores 706 is shown as being between ˜1 μm and ˜10 μm.

In this way, a slurry-based pre-lithiation layer for a cathode of a lithium-ion battery is provided. In one example, a pre-lithiation reagent included in the pre-lithiation layer may exhibit increased compatibility with other slurry components during slurry manufacturing. In this way, a synergistic combination of nanoscale dimensions of the pre-lithiation reagent and a uniform dispersion thereof throughout the slurry used to form the pre-lithiation layer may increase contact of the pre-lithiation reagent with other uniformly dispersed slurry components (e.g., cathode catalysts, binders, conductive carbon additives, etc.), facilitate slurry processing, and improve overall slurry quality, thereby improving structural stability of the finally-formed pre-lithiation layer and increasing pre-lithiation activity during initial charge cycling of the lithium-ion battery including the finally-formed pre-lithiation layer.

Further, the slurry may be tailored such that the finally-formed pre-lithiation layer may at least partially infiltrate a porous cathode active material layer of the cathode, thereby reducing delamination and interfacial impedance issues. For example, a solids content and a composition of the slurry may be judiciously selected to realize a relatively low viscosity thereof. When the slurry is then cast onto the cathode active material layer, the viscosity of the slurry, the nanoscale dimensions of the pre-lithiation reagent, and the porosity of the cathode active material layer may synergistically increase a layer-to-layer adhesion by inducing infiltration of the slurry into the cathode active material layer (even to the point of obviating inclusion of a binder in the slurry). Additionally, by limiting a thickness of the finally-formed pre-lithiation layer, impedance therethrough may be correspondingly limited (in addition to further limiting delamination of the finally-formed pre-lithiation layer). Accordingly, electrochemical performance may be increased in the lithium-ion battery by providing a separate pre-lithiation layer formed via careful tuning of multiple interdependent parameters during slurry manufacturing and subsequent layer formation.

The disclosure also provides support for a slurry for forming a cathode pre-lithiation layer, the slurry comprising: a uniform dispersion of a nanoscale cathode pre-lithiation reagent in a solvent, wherein the slurry has a viscosity of up to 5000 cP at a shear rate of 100 s−1. In a first example of the system, the slurry has a viscosity of 100 to 5000 cP. In a second example of the system, optionally including the first example, the slurry has a viscosity of 10-100 cP. In a third example of the system, optionally including one or both of the first and second examples, the slurry has a solids content of 10-70%. In a fourth example of the system, optionally including one or more or each of the first through third examples, the nanoscale cathode pre-lithiation reagent is composed of one or more of Li₃N, Li₂O, Li₂O₂, Li₂S, Li₅FeO₄, Li₂CO₃, Li₂C₂O₄ a Li₂S/M nanocomposite, a LiF/M nanocomposite, and a Li₂O/M nanocomposite, where M is one or more metals. In a fifth example of the system, optionally including one or more or each of the first through fourth examples, the uniform dispersion further comprises a cathode catalyst which catalyzes decomposition of the nanoscale cathode pre-lithiation reagent, and wherein the cathode catalyst comprises an inactive cathode catalyst composed of one or more non-lithiated metal oxides or non-lithiated metal phosphates and/or an active cathode catalyst composed of one or more lithium metal oxides or lithium metal phosphates. In a sixth example of the system, optionally including one or more or each of the first through fifth examples, the cathode catalyst is included at 50 wt % or less of the slurry, and wherein no additional cathode active material is included. In a seventh example of the system, optionally including one or more or each of the first through sixth examples, no cathode catalyst is included. In a eighth example of the system, optionally including one or more or each of the first through seventh examples, the uniform dispersion further comprises a binder, the binder being composed of one or more of PAN, PEG, PVDF, PTFE, PHFP, PMMA, PAA, poly(4-vinylpyridine), polyvinylpyrrolidone, a CMC derivative, or a copolymer thereof. In a ninth example of the system, optionally including one or more or each of the first through eighth examples, no binder is included. In a tenth example of the system, optionally including one or more or each of the first through ninth examples, the uniform dispersion further comprises a conductive carbon additive, the conductive carbon additive being composed of one or more of carbon black, carbon fibers, carbon nanoparticles, CNTs, graphene oxide, and graphene, and wherein the solvent is composed of one or more of DMF, NMP, DMAc, DMSO, MeCN, THF, and toluene.

The disclosure also provides support for a lithium-ion battery, comprising: a positive electrode, a negative electrode, and a separator interposed between the positive and negative electrodes, wherein the positive electrode comprises: a positive electrode substrate comprising a positive electrode current collector and a porous positive electrode active material layer, the porous positive electrode active material layer being coated on a first side of the positive electrode current collector opposite to a second side of the positive electrode current collector, where the second side of the positive electrode current collector faces the separator, and a pre-lithiation layer coated on the porous positive electrode active material layer opposite to the positive electrode current collector, the pre-lithiation layer being composed of a uniform dispersion of a pre-lithiation reagent and one or more additives, wherein the porous positive electrode active material layer and the pre-lithiation layer are formed as separate slurry-based coatings, and wherein a porosity of the porous positive electrode active material layer is greater than 40%. In a first example of the system, the one or more additives comprises one or more of a catalyst catalyzing decomposition of the pre-lithiation reagent during pre-lithiation, a binder, and a conductive carbon additive. In a second example of the system, optionally including the first example, the pre-lithiation layer has an overall thickness of up to 200 μm, wherein the pre-lithiation layer extends above the porous positive electrode active material layer up to a maximum extent and/or infiltrates into the porous positive electrode active material layer up to a maximum infiltration depth, and wherein a sum of the maximum extent and the maximum infiltration depth is equal to the overall thickness.

The disclosure also provides support for a method, comprising: milling a homogeneous mixture to form a cathode pre-lithiation slurry, the homogeneous mixture comprising a cathode pre-lithiation reagent, casting the cathode pre-lithiation slurry onto a porous cathode active material layer coated on a cathode current collector to form a slurry-coated cathode substrate, drying the slurry-coated cathode substrate, and calendering the dried slurry-coated cathode substrate, wherein the cathode pre-lithiation slurry has a viscosity of up to 5000 cP at a shear rate of 100 s−1, wherein the porous cathode active material layer is formed by casting an additional, separate slurry onto the cathode current collector prior to casting the cathode pre-lithiation slurry. In a first example of the method, the cathode pre-lithiation reagent is in particulate form, and wherein milling the homogeneous mixture comprises milling the cathode pre-lithiation reagent to a D50 size of 300 nm or less. In a second example of the method, optionally including the first example, the porous cathode active material layer is dry prior to the cathode pre-lithiation slurry being cast thereon. In a third example of the method, optionally including one or both of the first and second examples, the porous cathode active material layer is wet prior to the cathode pre-lithiation slurry being cast thereon, and wherein a porosity of the porous cathode active material layer is increased when the slurry-coated cathode substrate is dried. In a fourth example of the method, optionally including one or more or each of the first through third examples, the slurry-coated cathode substrate is dried at a temperature between 20 and 300° C. In a fifth example of the method, optionally including one or more or each of the first through fourth examples, the homogeneous mixture further comprises one or more additives uniformly dispersed in a non-aqueous solvent with the cathode pre-lithiation reagent, the one or more additives comprising one or more of a cathode catalyst, a binder, and a conductive carbon additive.

In another representation, a cathode for a lithium-ion battery, the cathode comprising: a cathode current collector; a cathode active material layer having a porosity of between 30% and 50%; and a cathode pre-lithiation layer including a uniform dispersion of a nanoscale cathode pre-lithiation reagent. In a first example of the cathode, the cathode pre-lithiation layer is formed by drying a cathode pre-lithiation slurry having a viscosity of 10 to 5000 cP at a shear rate of 100 s⁻¹, such that the cathode pre-lithiation layer at least partially infiltrates pores of the cathode active material layer. A second example of the cathode optionally includes the first example, and further includes wherein the cathode active material layer is interposed between the cathode current collector and the cathode pre-lithiation layer. A third example of the cathode optionally includes one or more of the first and second examples, and further includes wherein the cathode pre-lithiation layer is interposed between the cathode current collector and the cathode active material layer. A fourth example of the cathode optionally includes one or more of the first through third examples, and further includes wherein the uniform dispersion further comprises one or more of a cathode catalyst, a binder, and a conductive carbon additive. A fifth example of the cathode optionally includes one or more of the first through fourth examples, and further includes wherein each of the cathode pre-lithiation layer and the cathode active material layer includes a cathode active material.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A slurry for forming a cathode pre-lithiation layer, the slurry comprising:
a uniform dispersion of a nanoscale cathode pre-lithiation reagent in a solvent,
wherein the slurry has a viscosity of up to 5000 cP at a shear rate of 100 s⁻¹.

2. The slurry of claim 1, wherein the slurry has a viscosity of 100 to 5000 cP.

3. The slurry of claim 1, wherein the slurry has a viscosity of 10-100 cP.

4. The slurry of claim 1, wherein the slurry has a solids content of 10-70%.

5. The slurry of claim 1, wherein the nanoscale cathode pre-lithiation reagent is composed of one or more of Li₃N, Li₂O, Li₂O₂, Li₂S, Li₅FeO₄, Li₂CO₃, Li₂C₂O₄ a Li₂S/M nanocomposite, a LiF/M nanocomposite, and a Li₂O/M nanocomposite, where M is one or more metals.

6. The slurry of claim 1, wherein the uniform dispersion further comprises a cathode catalyst which catalyzes decomposition of the nanoscale cathode pre-lithiation reagent, and wherein the cathode catalyst comprises an inactive cathode catalyst composed of one or more non-lithiated metal oxides or non-lithiated metal phosphates and/or an active cathode catalyst composed of one or more lithium metal oxides or lithium metal phosphates.

7. The slurry of claim 5, wherein the cathode catalyst is included at 50 wt % or less of the slurry, and
wherein no additional cathode active material is included.

8. The slurry of claim 1, wherein no cathode catalyst is included.

9. The slurry of claim 1, wherein the uniform dispersion further comprises a binder, the binder being composed of one or more of PAN, PEG, PVDF, PTFE, PHFP, PMMA, PAA, poly(4-vinylpyridine), polyvinylpyrrolidone, a CMC derivative, or a copolymer thereof.

10. The slurry of claim 1, wherein no binder is included.

11. The slurry of claim 1, wherein the uniform dispersion further comprises a conductive carbon additive, the conductive carbon additive being composed of one or more of carbon black, carbon fibers, carbon nanoparticles, CNTs, graphene oxide, and graphene, and wherein the solvent is composed of one or more of DMF, NMP, DMAc, DMSO, MeCN, THF, and toluene.

12. A lithium-ion battery, comprising:
a positive electrode, a negative electrode, and a separator interposed between the positive and negative electrodes,
wherein the positive electrode comprises:
a positive electrode substrate comprising a positive electrode current collector and a porous positive electrode active material layer, the porous positive electrode active material layer being coated on a first side of the positive electrode current collector opposite to a second side of the positive electrode current collector, where the second side of the positive electrode current collector faces the separator; and
a pre-lithiation layer coated on the porous positive electrode active material layer opposite to the positive electrode current collector, the pre-lithiation layer being composed of a uniform dispersion of a pre-lithiation reagent and one or more additives,
wherein the porous positive electrode active material layer and the pre-lithiation layer are formed as separate slurry-based coatings, and
wherein a porosity of the porous positive electrode active material layer is greater than 40%.

13. The lithium-ion battery of claim 12, wherein the one or more additives comprises one or more of a catalyst catalyzing decomposition of the pre-lithiation reagent during pre-lithiation, a binder, and a conductive carbon additive.

14. The lithium-ion battery of claim 12, wherein the pre-lithiation layer has an overall thickness of up to 200 μm,
wherein the pre-lithiation layer extends above the porous positive electrode active material layer up to a maximum extent and/or infiltrates into the porous positive electrode active material layer up to a maximum infiltration depth, and
wherein a sum of the maximum extent and the maximum infiltration depth is equal to the overall thickness.

15. A method, comprising:
milling a homogeneous mixture to form a cathode pre-lithiation slurry, the homogeneous mixture comprising a cathode pre-lithiation reagent;
casting the cathode pre-lithiation slurry onto a porous cathode active material layer coated on a cathode current collector to form a slurry-coated cathode substrate;
drying the slurry-coated cathode substrate; and
calendering the dried slurry-coated cathode substrate,
wherein the cathode pre-lithiation slurry has a viscosity of up to 5000 cP at a shear rate of 100 s⁻¹,
wherein the porous cathode active material layer is formed by casting an additional, separate slurry onto the cathode current collector prior to casting the cathode pre-lithiation slurry.

16. The method of claim 15, wherein the cathode pre-lithiation reagent is in particulate form, and
wherein milling the homogeneous mixture comprises milling the cathode pre-lithiation reagent to a D50 size of 300 nm or less.

17. The method of claim 15, wherein the porous cathode active material layer is dry prior to the cathode pre-lithiation slurry being cast thereon.

18. The method of claim 15, wherein the porous cathode active material layer is wet prior to the cathode pre-lithiation slurry being cast thereon, and
wherein a porosity of the porous cathode active material layer is increased when the slurry-coated cathode substrate is dried.

19. The method of claim 15, wherein the slurry-coated cathode substrate is dried at a temperature between 20 and 300° C.

20. The method of claim 15, wherein the homogeneous mixture further comprises one or more additives uniformly dispersed in a non-aqueous solvent with the cathode pre-lithiation reagent, the one or more additives comprising one or more of a cathode catalyst, a binder, and a conductive carbon additive.
